(19) United States
(12) Patent Application Publication
(10) Pub. No.: US 2015/0052080 A1
(43) Pub. Date: Feb. 19, 2015

(54) SYSTEMS AND METHODS FOR MANAGING REAL ESTATE INVESTMENTS

(71) Applicant: CREISOFT, INC., Charlotte, NC (US)

(72) Inventor: Ryan Letzeiser, Charlotte, NC (US)

(21) Appl. No.: 14/460,956

(22) Filed: Aug. 15, 2014

Related U.S. Application Data
(60) Provisional application No. 61/866,209, filed on Aug. 15, 2013.

(51) Int. Cl. G06Q 50/16; G06F 3/0488

(52) U.S. Cl. CPC G06Q 50/163; G06Q 40/06; G06F 3/0488
USPC 705/36 R

(57) ABSTRACT

Systems and methods are provided for managing real estate investments. A commercial real estate investment management system may be implemented in a software or application. Tools may be provided that may aid in managing the commercial real estate investments. In some embodiments, tools or features may include a live offering memo, geospatial touring, and/or side by side scenario comparison.

### CROSS-REFERENCE

This application claims the benefit of U.S. Provisional Application No. 61/866,209 filed Aug. 15, 2013, which application is incorporated herein by reference in its entirety.

### BACKGROUND OF THE INVENTION

Real estate investments require financial analysis of data and consideration, particularly for commercial real estate. Software is available that enables individuals to track real estate investments; however, conventional real estate management software is inflexible and generally cannot handle the myriad of financial scenarios. A need exists for improved tools and systems to manage real estate investments.

### SUMMARY OF THE INVENTION

Systems and methods of sharing real estate information may be provided. Marking and financial data (e.g., for commercial real estate) may be shared through a cloud based system in order to conduct financial analysis. Real estate investments may be tracked using a system that includes multiple tools. Examples of the tools or features may include a live offering memo, tools for touring a real estate investment property, and/or a side by side scenario comparison. Additional tools or features are described elsewhere herein.

An aspect of the invention may be directed to a computer implemented method of displaying multiple real estate scenarios, said method comprising: displaying, on a display of a user device, categories of real estate information to be displayed in a linear fashion; displaying, on the display of the user device, corresponding original values for the categories of real estate information in a linear fashion that is parallel to the categories of real estate information; receiving, via a user input interface of the user device, a user input to create an additional scenario; displaying, on the display of the user device in response to the user input, an additional scenario with corresponding additional values for the categories of real estate information in a linear fashion that is parallel to the categories of real estate information, wherein the corresponding additional values are the same as the corresponding original values; and receiving, via the user interface of the user device, a user input to alter at least one of the corresponding additional values.

Additional aspect of the invention may be directed to a system for displaying a program, said system comprising: a user input interface configured to receive a user input; a display screen on a user device comprising a user interface that displays (1) categories of real estate information to be displayed in a linear fashion, (2) corresponding original values for the categories of real estate information in a linear fashion that is parallel to the categories of real estate information, and (3) an additional scenario, in response to a user input to create the additional scenario through the user input interface, with corresponding additional values for the categories of real estate information in a linear fashion that is parallel to the categories of real estate information, wherein the corresponding additional values are the same as the corresponding original values; and a processor that is programmed to receive a signal from the user input interface indicative of a user input to alter at least one of the corresponding additional values and generate a display signal that causes the display screen to display the altered corresponding additional value.

Furthermore, an aspect of the invention is directed to a computer implemented method for providing a real estate tour comprising: receiving, and storing in memory, geospatial information for a tour having one or more hot spots; associating, and storing in the memory, additional information with the one or more hot spots; receiving, from a user device having geospatial tracking capability, information about the geospatial location of the user; and displaying, if the user device is within a predetermined distance of an individual hot spot of the one or more hot spots, the additional information associated with the individual hot spot. The method may make use of a wireless proximity device if geospatial data is unavailable most often for interior space tours. The use of a wireless technology that is not Wi-Fi enabled (i.e., blue tooth technology) may give the user access to the same set of features when geospatial data is not available. Wireless proximity devices may include any type of device as described elsewhere herein, including wearable devices (e.g., Google Glass, Oculus Rift) that can create an augmented reality picture of an un-built property using the same proximity based information, be it device or geospatially based.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of a data flow of property offering and analysis data in accordance with an embodiment of the invention.

FIG. 2 shows an example of a scenario tool provided in accordance with an embodiment of the invention.

FIG. 3 shows an example of a deal room network flow chart.

FIG. 4A provides an implementation of a real estate investor tour in accordance with an embodiment of the invention.

FIG. 4B provides an example of a flow chart illustrating a geospatial application.

FIG. 5 illustrates an example of a map interface with one or more targeted geospatial location.

FIG. 6A shows an example of original real estate financial data to be compared.

FIG. 6B shows a user interface through which additional scenarios can be compared to the original real estate financial data.

FIG. 7A shows an example of a commercial property dashboard.

FIG. 7B shows an additional example of a commercial property dashboard.

FIG. 7C shows data pertaining to dashboard activity.

FIG. 8A shows an example of a user interface through which real estate financial data can be analyzed.

FIG. 8B shows an additional example of a user interface through which real estate financial data can be analyzed.

FIG. 9A shows an example of a user interface showing real estate financials.

FIG. 9B shows an additional example of a user interface showing real estate financials.

FIG. 9C shows an example of a user interface for finalization after all scenarios have been compared.

FIG. 10 shows an example of a user interface with real estate comparables.

FIG. 11 shows an example of a system for managing real estate investments in accordance with an embodiment of the invention.

FIG. 12 illustrates example components of a device for implementing aspects of the present invention.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and methods for managing real estate investments. Various aspects of the invention described herein may be applied to any of the particular applications set forth below or for any other financial investment management. The invention may be applied as a standalone device, or as part of an integrated commercial real estate system. It shall be understood that different aspects of the invention can be appreciated individually, collectively, or in combination with each other.

A real estate investment management system may be implemented in a software or application. The real estate investment management system may be used for commercial real estate investments. One or more tools may be provided that may aid in managing the commercial real estate. In some embodiments, tools or features may include a live offering memo, geospatial touring, and/or side by side scenario comparison. Additional tools or features may be provided. The tools or features may be accessed by devices of users. In some embodiments, multiple users may interact with the system to access and/or modify real estate investment information for a particular property or series of properties simultaneously and be able to view activities of the other users.

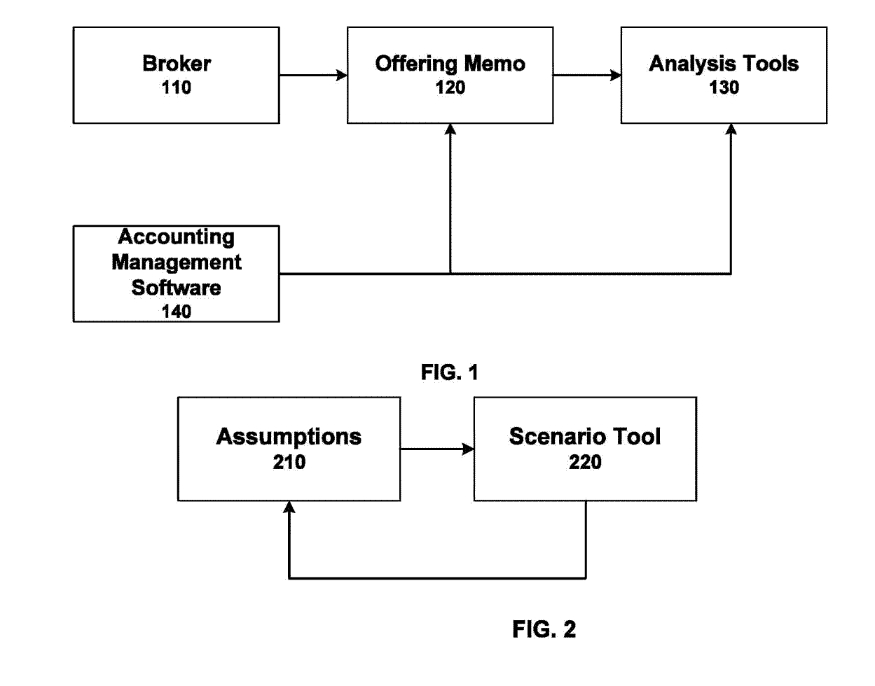

FIG. 1 shows an example of a data flow of property offering and analysis data in accordance with an embodiment of the invention. Typically, for commercial real estate transactions, one or more licensed real estate professional 110 (e.g., broker) will provide an offering memorandum (memo) 120. An offering memo may be a legal document that may state objectives, risks, and/or terms of a real estate investment. The offering memo may include financial statements, management biographies, and/or detailed description of the real estate property. The offering memo may provide potential buyers with information on the offering. The licensed real estate professional may put together the offering memo with financials and comparables using the system described herein. The licensed real estate professional may put together the offering memo using a computer-implemented program or application as described elsewhere herein.

An offering memo 120 may be a live version. Historical information may be stored for analysis and trends. Updates to the offering memo may be made in real time. In some instances, updates to the memo may be provided via the licensed real estate professional 110 and/or an accounting management software 140. As access to new data is provided, such information may be incorporated into the offering memo. The information may be incorporated via manual entry, automated entry via a processor, or any combination thereof. Updates to an offering memo may be provided to relevant users via email, text, alert, phone call, or other communication technique. In some instances, the communication regarding the update to the memo may include substantive information about the update, or may include the mere fact that the memo has been updated.

Analysis tools 130 may be used to analyze information provided through the offering memo 120. Information from the offering memo may be provided to the analysis tools in an automated fashion. Information pertaining to the offering memo may be stored in memory, and may be accessible by the analysis tools, which may analyze the information with aid of a processor. The analysis tools may analyze the information in an automated fashion without requiring human intervention. The analysis tools may cause analyzed information to be displayed to a user. The user may or may not interact with the analysis tools to vary the terms of the analysis or view selected analyzed data. Such information from the offering memo to the analysis tools may be provided in real-time or a short period of time of the accounting management software receiving the data. For example, the data may be conveyed to the offering memo and/or analysis tools within one or more milliseconds, hundredths of a second, tenths of a second, second, several seconds, minutes, several minutes, or hours.

In some instances, accounting management software 140 may feed data into the offering memo 120 and analysis tools 130 in real time. The accounting management software may receive and/or store data in memory. The accounting management software may send the data to the offering memo and/or analysis tools in an automated fashion with aid of a processor. Such information may be provided in real-time or a short period of time of the accounting management software receiving the data. For example, the data may be conveyed to the offering memo and/or analysis tools within one or more milliseconds, hundredths of a second, tenths of a second, second, several seconds, minutes, several minutes, or hours.

A user of the system may see the latest update date time stamp. For example, the accounting management software may be implemented on a machine having a clock or other time keeping device. The timestamp of when the information is sent according to the clock of the machine may be transmitted along with the sent updated data. Alternatively, the offering memo and/or analysis tool may be implemented on a machine having a clock or other time keeping device. The time stamp of when the information is received according to the machine may be associated and/or stored with the received updated data. Thus, a user may be informed of when the accounting management software has updated the offering memo and/or analysis tools. Similarly, the user may be informed of when the offering memo has fed information to the analysis tools.

In some embodiments, analysis tools 130 may be online or offline. If the analysis tools are online, they may incorporate any updates in real-time. If the analysis tools are offline, and new updates have occurred, a relevant user may receive a communication regarding new updates. For example, upon online communication of the analysis tools, the user may be prompted to receive the new updates. In another example, a user may receive a communication (e.g., email, text, alert, phone call) while offline that new updates will be provided upon online connectivity. Once accepted, all scenarios may be refreshed with the latest information. The user may have the ability to review historical analysis if needed. Thus, the user may be able to view and/or compare historical analysis with the newly updated analysis.

The analysis tools 130 may have features to provide information in various formats. For example, the analysis tools may be able to email and/or export information in various document types, such as PDFs, spreadsheet (e.g., Excel files), word processing files, image files, or any other format.

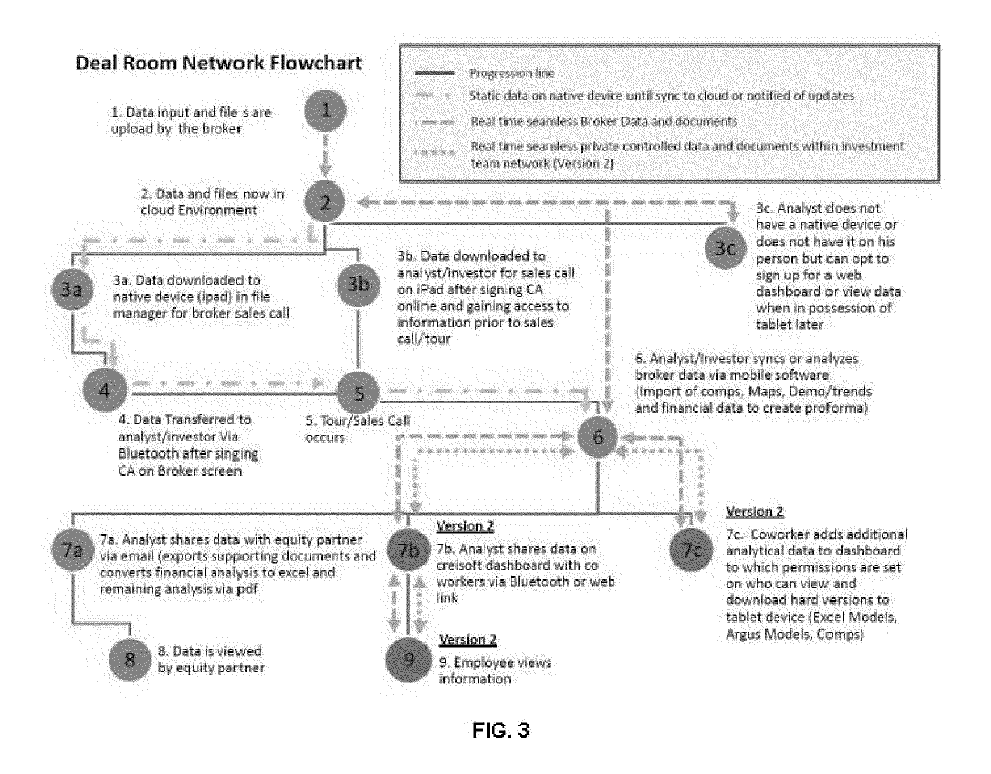

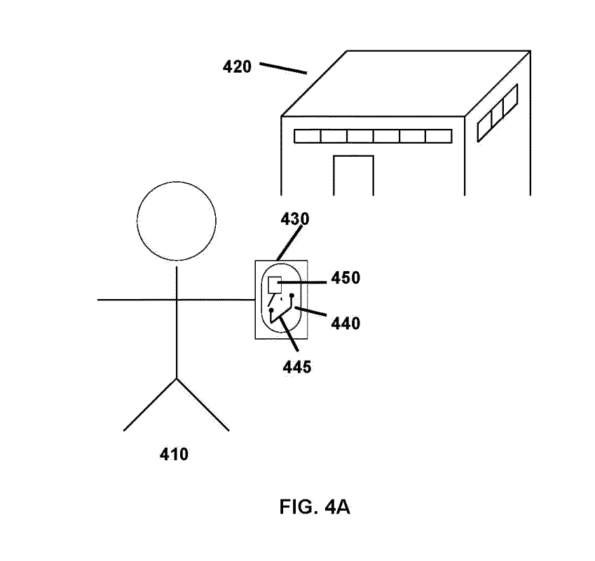

FIG. 3 shows an example of a deal room network flow chart. The deal room network flow chart may provide examples of how data can be provided from one or more device to another device and/or analyzed. Data may be provided in different manners. For example, some data may be static data on a native device until synchronized to a cloud computing environment or notified of updates. Other data may be real time seamless licensed real estate professional data and documents. Some data may be real time seamless private controlled data and documents within an investment team network.

Data input and files may be provided by a licensed real estate professional (1). The data input may be manually entered by a licensed real estate professional or may be uploaded from pre-existing files. In some embodiments, the data may be exported from another environment or type of document.

The data and files may then be provided in a cloud environment (2). The cloud environment may have a cloud computing infrastructure that may include a plurality of devices that are connected through a real-time communication network. In some instances, the cloud environment may include a large number of devices (e.g., computers (personal computers, servers, laptops), smartphones, tablets, personal digital assistants, wearable devices). The cloud computing environment may be a distributed computing environment over the network that may include an ability to a program or application on many connected devices simultaneously. The data may be provided from the licensed real estate professional into the cloud environment in a real time and seamless manner.

From the cloud environment, the data may be downloaded to a native device in a file manager for a licensed real estate professional sales call (3a). The native device may be any type of device such as, but not limited to, a tablet (e.g., iPad, Surface, Galaxy, Fire), smartphone (e.g., iPhone, Android-based phone, Windows phone, Blackberry), computer (e.g., personal computer, server, laptop, desktop), personal digital assistant, or a wearable device (e.g., iWatch, Google Glass, Oculus Rift). The data may be provided to the native device, when the device is synched to the cloud environment. The native device may be notified of updates and to connect to the cloud environment.

In another example, the data may be downloaded to a device of an analyst/investor for a sales call (3b). This may occur after signing CA online and gaining access to information prior to a sales call or tour. The device of the analyst/investor may be any type of device, including those described elsewhere herein. The data may be provided to the device, when the device is synched to the cloud environment. The device may be notified of updates and to connect to the cloud environment.

The data may optionally be provided to an analyst who does not have a native device (3c), or does not have the native device on his or her person. The analyst may opt in to sign up for a web dashboard (e.g., accessible via another device) or view data when in possession of his or her native device at a later time. In some embodiments, communications via the web dashboard may be provided in real-time seamless communications.

Data may be transferred to an analyst/investor after signing CA on a licensed real estate professional user interface (4). In some embodiments, after data has been provided to the licensed real estate professional via a wireless connection (e.g., Bluetooth). The data may be transferred from the licensed real estate professional native device. In some embodiments, the data may be static data that is remains on the native device unless the analyst/investor device is synched to the cloud or is notified of updates.

A tour/sales call may occur (5). The tour/sales call may occur after the licensed real estate professional and/or the analyst/investor has received and/or viewed the data (4, 3b). The tour/sales call may occur via telephone, or other device which may permit real-time communications. For example, the tour/sales call may occur using audio and/or visual communications.

The analyst/investor may synch or analyze licensed real estate professional data via mobile software (6). This may include import of comparables, maps, demo/trends, and/or financial data to create proforma information. This may optionally occur after the tour/sales call (5) occurs. In some embodiments, this may occur after the analyst/investor has viewed the data (e.g., via the analyst/investor native device (3b) or a web dashboard (3c)).

The analyst/investor may share data with any and all parties that the investor deems as a viable party associated with the investment (7a). An example of said parties may include an equity partner. The data may be shared via email or other forms of communication. Supporting documents may be exported and financial analysis may be converted to a desired format. For example, financial analysis may be converted to a spreadsheet format (e.g., Excel) and remaining analysis may be provided in a visual format (e.g., pdf). The data may then be viewed by said parties. (8).

In some embodiments, the analyst/investor may share data on a system dashboard with co-workers (7b). Such data may be shared via a wireless connection (e.g., Bluetooth), web link, or other form of communication. Such communications may be direct communications between devices, or communications over a network (e.g., local area network (LAN), wide area network (WAN) such as the Internet, telecommunications network, or data network). The co-worker may view the information (9).

The co-worker may add additional analytical data to the dashboard (7c). The dashboard permission may be set on who can view and download information to various devices. For example, permissions may be set on who can view and download hard versions to a tablet device (e.g., models (Excel models, Argus models), comparables). Such communications may be provided via real time seamless data communications. Such real time communications may occur using private controlled data and documents within an investment team network.

A real estate investment system may include one or more tools that may be useful to users of the system. For example, a tour of real estate properties may be prepared and viewed.

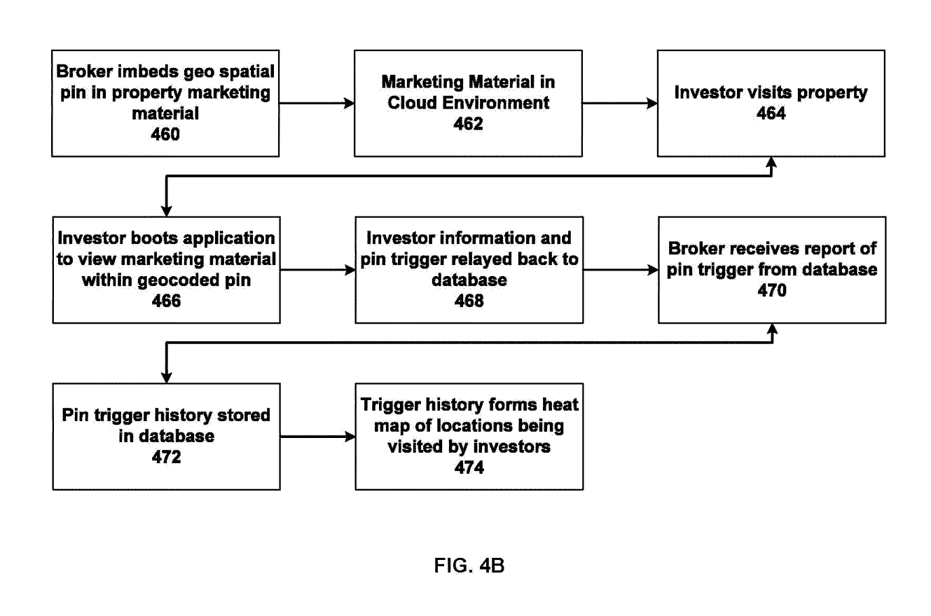

FIG. 4A provides an implementation of a real estate investor tour in accordance with an embodiment of the invention. In some embodiments, licensed real estate professionals (e.g., brokers) may create a tour or other geospatial-based information pertaining to one or more real estate property. The real estate property may be commercial real estate property that may be shown to investors. Any description herein of investors may relate to any purchaser or buyer (e.g., actual or potential), or any individual representing the purchaser or buyer (e.g., actual or potential).

One or more licensed real estate professionals may enter or upload geospatial information. For example, a map may be uploaded and associated with longitude and latitude coordinates. The longitude and latitude coordinates may be related to locations of real estate properties, features within real estate properties, driving tour locations, or other hot spots having additional information. In some instances, a licensed real estate professional may locate an area within a map using mapping tools (e.g., Google Earth without having to know the longitude and latitude coordinates).

Licensed real estate professionals may design tours to show potential investors a given area, set of buildings, or other real estate properties and offerings (e.g., shopping centers, land, undeveloped space, etc.). Tours may be any distance or duration (e.g., on the order of several meters, hundreds of meters, thousands of meters, or miles). Tours may be designed to be driving tours (e.g., stopping at one or more properties at different locations), or walking tours (e.g., walking around several buildings in a complex, or within a single building). In some instances, the tours may include indoor walking tours to highlight building features and other areas of interest.

A licensed real estate professional may use a device to create the tour. The device may be a tablet, smartphone, or other mobile device, or any other device described elsewhere herein. The licensed real estate professional may create/record the tour by “pinning” the route in order of a desired travel path. Tour may include a start, one or more scheduled stop, and end. The licensed real estate professional may draw out the route in freehand. The licensed real estate professional may create one or more points along the path and a path may be automatically provided between the points. The path may be a walkable path, or a drivable path. The licensed real estate professional may be able to adjust the path. In some instances, the licensed real estate professional may be able to travel along the desired route using a device, wherein the device location has a geospatial tracker that can be used to record the licensed real estate professional's travel path. The travel path of the tour may include one or more hot spots. The licensed real estate professional may add links, images, video, audio, notes, or any other additional information to the various hot spots on the tour, which may permit individuals interacting with the tour to review and interact with this information while taking the tour. The tour may be a walking tour. For example, the tour may take place on a property and may include one, two or more hot spots on the property. For example, the hot spots may be provided at different regions, floors, rooms, portions of the rooms, portions of the grounds of the property. In other instances, the tour may be driving tour. The tour may be on a single property or may travel between multiple properties. One, two or more hot spots may be provided at a single property or may be provided between multiple properties. The licensed real estate professional may be able to save the tour in the real estate management system. The tour information may be stored in a memory of the system. The stored tour information may include geospatial information for the tour; the location of the start, scheduled stops, hot spots, or end; and/or additional information relating to the one or more hot spots.

Investors may be granted access to a tour based on privileges set in the real estate management system. The real estate management software application may have one or more privilege settings which may determine which users may have access to which features or information. The privilege settings may be determined based on the user identity (who the individual user is), or the user position (e.g., investor vs. licensed real estate professional).

When an investor is ready to take a tour, he or she may navigate to the property tour on the investor device (e.g., tablet, smartphone or other mobile device). The investor device may have a geospatial tracking component (e.g., GPS device, or use cell tower geolocation techniques). Alternatively, the investor real estate management software may recognize where the investors are within a certain proximity to a tour path using any other technique.

The investor may be directed to a start of the tour path. In some embodiments, if an investor is detected to be within a predetermined distance of the tour path start (or any other portion of the tour path), the investor may be directed to the start of the tour path. For instance, an alert (e.g., visual, auditory, tactile alert) may be provided when a user device is within a predetermined distance of the start of the tour path. In some instances, the licensed real estate professional who creates the tour may be able to configure the rules pertaining to guiding the investor and/or proximity alerts provided to the investor. For example, the licensed real estate professional may desire the investor to begin at the start of the tour no matter what. Alternatively, the licensed real estate professional may permit the investor to start at any point along the tour, or any scheduled stop or hot spot along the tour.

In some embodiments, when an investor or other user has hit an acceptable proximity to the tour, the investor (or other user) may be prompted to take the tour. In some instances, the user may hit an acceptable proximity, when the user is within a predetermined distance of the start of the tour, or any designated portion of the tour (e.g., tour route, scheduled stop, hot spot, end). The predetermined distance may be any amount (e.g., on the order of miles, hundreds of meters, 100 meters, 50 meters, 25 meters, 15 meters, 5 meters, or 1 meter). In some instances, when the user device is detected to be within the predetermined threshold, an alert may be provided via the user device. The user device may have a user interface which may show a map of the tour, or other information relating to the tour. In some instances, the prompt to take the tour may appear on the user's device. Additional information relating to the tour may appear on the user's device without requiring additional user input.

For example, if the user comes within a predetermined distance of a hot spot, additional information about the hot spot may be displayed on the user's device. For example, if the user comes within a predetermined distance of a particular real estate property feature, additional information about that feature may automatically pop up on the user's device. An alert, such as a visual, haptic, and/or audio alert may be provided when a user comes within a predetermined distance of a hot spot.

A user (e.g., investor) may interact with a real estate management software or application (e.g., running on the user device) to start the tour. The tour may navigate the user through the specified tour path. In some instances, the tour path may have a fixed predetermined route. In some instances, multiple alternative routes may be provided. The tour path may be static, or may be dynamic and updated based on the user location and/or travel history.

The real estate management software or application may track the time of the tour and/or the specific route taken. The real estate management software or application may be able to discern whether the user follows the specified tour path, or deviates from the tour path. The real estate management software or application may offer information to the user based on information associated with the tour in the real estate management platform. The real estate management software or application may also request information from the user during or after the tour. For instance, survey information about the property features that a user is viewing in real time may be provided. Thus, the tour feature may rely on mobile technology utilized the user device (e.g., GPS, or other locating techniques) to monitor user location and capture real time statistics and feedback about the tours within the real estate management platform.

FIG. 4A shows a user 410 capable of participating in a real property tour. The user may be an investor, licensed real estate professional, potential partner, or any other individual, or individual representative of an entity that may participate in a real estate transaction. In some embodiments, only registered users of a real estate investment system may be capable of using a real property tour feature. In one example, only investors or other individuals, to whom a licensed real estate professional has granted permission, may be able to participate in the tour created by the licensed real estate professional.

The user may encounter one or more real estate property 420 or portion of a real estate property. The real estate property may be a commercial real estate property, which may include but are not limited to offices, industrial properties, retail properties, multi-family properties, hotels, warehouses, storage, land, lots, or undeveloped properties. The property encountered by the user may be a building, a complex with multiple buildings, a portion of a building, lots, land, or other structures or undeveloped property.

The user may have a user device 430. The user device may be a mobile device that may be carried by the user. For example, the user device may be a tablet, smartphone, cell phone, personal digital assistant, laptop, wearable device or other device. The user device may have a memory and/or processor. The memory may store data and/or non-transitory computer readable media comprising code, logic or instructions to perform one or more step. The processor may be capable of executing one or more step. For example, the processor may be a programmable processor capable of executing steps in accordance with the non-transitory computer readable media.

The user device may provide information about the geospatial location of the user device. For example, the user device may have a global positioning system (GPS) tracker. In another example, the user device may communicate with one or more cell tower or other devices of known location. Another example may include the use of a wireless device that has a proximity sensor associated with it. Techniques, such as triangulation techniques may be utilized to determine the location of the user device. The user device location may be determined with a desired degree of specificity. For example, the location of the user device may be determined to within a radius of 1 mile, several hundred meters, tens of meters, several meters, 1 meter, or less.

The user device may have a display which may be capable of showing information to a user. For example, the display may be a screen, such as a touchscreen. The user device may optionally provide audible information (e.g., via one or more speaker) or haptic information (e.g., may vibrate). The display may be capable of showing a user interface for a real estate management software or application, or via web dashboard. The user device may be capable of accepting an input from a user. For example, a user input device may be used including, but not limited to, touchscreen, keyboard, mouse, joystick, trackball, touchpad, microphone, motion sensor, camera, infrared sensor, or any other input device. In some instances, a display may also be capable of receiving input from the user (e.g., touchscreen).

In one example, the user device may show a map or other information relating to a tour. The map may show the user's surroundings and/or information relating to the tour, such as a tour route. The tour route may be confined to one or more drivable roads, walkable roads or pathways, hallways, rooms, or any other area traversable by the user. In some instances, a visual indicator 440 may be provided showing one or more point of interest. Examples of points of interest may include hot spots, scheduled stops, lots, sites, buildings, rooms, or features of real estate property. The points of interest may have any level of granularity. The points of interest may refer to entire properties, structures on properties, portions of properties, rooms of properties, or specific features of properties. In some instances, one, two or more points of interests may be provided during a tour.

A tour route 445 may be visually displayed. The tour routes may connect one or more points of interest. In some instances, the tour route may have a start and an end. The tour route may have a recommended direction, or may be agnostic as to which direction to traverse the tour route. In some embodiments, the tour route may be a driving tour route, and may be confined to drivable roads. A driving tour route may take a user to multiple properties in an area, or to multiple buildings within a property. In some embodiments, the tour route may be a walking tour route, and may be confined to walkable paths. The walking tour may be within a structure, outside a structure, or any combination thereof. The user's position on or near the tour route may be displayed. For instance, a map may display the location of the user device relative to the tour.

In some embodiments, the tour route 445 may have a single fixed path. Alternatively, multiple paths may be provided that a user may select in the alternative. The user may or may not backtrack on a tour route. In some instances, the tour route may be static and may not change as a user traverses the route. In another embodiment, the tour route may be dynamic and may be updated based on the user's travel route. For instance, if the user steps off the recommended tour route, the tour route may be updated to route the user back onto the tour route.

A user may be automatically informed, via the user device, when the user is within a predetermined distance of the tour route. This may occur for any portion of the tour route, or predetermined portions of the tour route (e.g., the user may be alerted when the user comes within a predetermined distance of the start of the tour route, or a stopping point or hot spot of the tour route.

In some embodiments, additional information may be associated with one or more points of interest 440. The additional information may be displayed 450 on the user device when the user comes within a predetermined proximity of the point of interest. For example, additional information about a point of interest may pop up when a user is within a mile, several hundred meters, 100 meters, 50 meters, 25 meters, 15 meters, 5 meters, or 1 meter of the point of interest. The additional information may have a visual component and/or audible or haptic component. For example, the device may vibrate to alert the user when the user is within the predetermined proximity of the point of interest. In some instances, the additional information may include notes, images, graphs, links, video, and/or audio. The information may refer to the particular point of interest whether it be an overall property, building or structure on a property, room of a property, or specific feature of a property. In some instances, the information may include historical or financial information relating to the point of interest. In some instances, the information (e.g., financial information) may have been selected by the licensed real estate professional. In some instances, the information may be updated in real time to reflect the latest information. In some instances, information from an offering memo and/or analyzed using one or more analysis tool may be provided. Any information that may be relevant for investors of commercial real estate may be provided.

In some instances, a user device may be a wearable device (e.g., Google Glass, Oculus Rift) that can create an augmented reality picture of an un-built property using proximity based information, be it device or geospatially based. For instance, a user may wear a device over the user's device during the tour, and the device may show an image of a property that is not yet built at the site where the property would be built. The image of the unbuilt property may be overlaid with the location that the unbuilt property would be built. In other instances, the device may be a handheld device that may show an image of the property that could be built at the site.

In some embodiments, when a user is no longer within the predetermined proximity of the point of interest, the additional information may be hidden or may cease. For example, if the device is detected to be outside the predetermined distance from the point of interest, a video explaining a particular feature may cease. Alternatively, the additional information may remain provided unless the user selects an option for the information to be hidden or to cease.

FIG. 4B provides an example of a flow chart illustrating a geospatial application. In some instances, a licensed real estate professional may help prepare a tour of a property for an investor, partner, purchaser or other entity. For example, property marketing material may be provided. A licensed real estate professional or other entity may imbed a geospatial pin in the property marketing material 460. In some embodiments, a user interface may be shown on a display of a device. The user interface may show a map or other geospatial visualization tool. The licensed real estate professional may be able to drop the geospatial pin at the desired location. For example, the licensed real estate professional may select (e.g., touch, click) on the location at which to drop the geospatial pin. In alternative embodiments, the licensed real estate professional may enter a latitude/longitude for the geospatial pin, or an address at which to provide the geospatial pin.

The property marketing material may be provided to a cloud environment 462. The marketing material may be stored in memory having a cloud computing infrastructure. The marketing material may be accessible by a plurality of devices capable of communicating with the cloud.

An investor may visit a property 464. An investor may be physically present at a property that the investor is to tour. The investor may use an application to view marketing material with the geo-coded pin 466. In some instances, the investor may have a device capable of accessing the cloud. The investor device may access the marketing material from the cloud environment. In some instances, the marketing material may be downloaded to the investor device. Alternatively, the investor device may be capable of showing the investor the marketing information without having to download the information. In some embodiments, the investor may view the material provided within the geo-coded pin. For example, the investor may approach a location of interest, and the pin may be displayed. In some instances, the investor device may have a geo-tracking component that may enable a system to determine whether the investor is in a proximity of a property or feature represented by the geo-coded pin. The information associated with the pin may be automatically displayed based on investor location, or the investor may select an option to view the information associated with the pin. The pin may be triggered automatically based on the investor device proximity to a point of interest, or may be triggered based on an input from the user (e.g., an input to view information associated with the pin).

Investor information and pin trigger may be relayed back to a database 468. The fact that the pin was triggered (e.g., by proximity of the investor to the point of interest, selection of the pin by the user) may be stored in memory. Investor information (e.g., including investor identity, properties/pins viewed by the investor) may be stored in memory as well. The database may include any memory, which may or may not be stored in a cloud computing environment.

The licensed real estate professional may receive a report of a pin trigger from the database 470. Such a report may occur in real-time, or may occur at predetermined time intervals. In some instances, the report may be provided in response to an event (e.g., the licensed real estate professional logging in, the licensed real estate professional selecting a refresh option, the licensed real estate professional selecting an update pin trigger option).

A pin trigger history may be stored in the database 472. For instance, the pin trigger history may include information on when various pins were triggered for various properties. For example, tours relating to multiple properties may be stored. The tours may include one or more pin. The trigger history of each pin may be stored in memory. Thus, the frequency of investor visits and/or access of information may be tracked, within a tour or across multiple tours. The pin trigger history may be indexed according to property, tours, licensed real estate professional, investor, or any other characteristic. The pin trigger history may include a time at which the pin trigger occurred. The time may be gathered using a clock or other time keeping component.

The pin trigger history may be used to form a heat map of locations being visited by investors 474. For example, pins that have been triggered more often, frequently, or recently may be displayed as having more ‘heat.’ A visual display may be provided showing a geographic map. A scope or location of the area shown by the geographic map may be controlled and/or altered by a user. The geographic map may include one or more visual indicator, such as color, regarding the ‘heat’ of certain properties. For example, the geographic map may include locations with one or more properties having one or more pins. The areas where the pins were triggered more may be shown in a different color from pins that were triggered less. In another example, the visual indicator of heat may be used by icons (e.g., number/density of icons, size of icons). The areas where pin were triggered more may be shown with a greater density of icons, or larger icons than areas where pins were triggered less. A user may be able to control parameters relating to the heat map. For example, a user may specify that the user wishes to see the heat within a time range (e.g., for all time, from 10 years ago to five years ago, within the past several years, within the past year, from 6 months ago to 3 months ago, within the past month, within the past week, within the past day). The time range may be from a point in time in the past to the present, or may be between two points in time in the past. Timestamps provided in the pin trigger history may be useful for determining whether a particular pin trigger falls within a designated time range. In some instances, depending on the time range, the pin trigger data may be normalized and/or scaled so that the heat map provides a visually discernible difference. For instance, range of number of pin triggers to cause a certain color to be displayed may differ depending on the time range. Thus, a user may be able to, in a single view, determine which geographic areas or properties have generated more investor visits. This may be indicative of interest by investors.

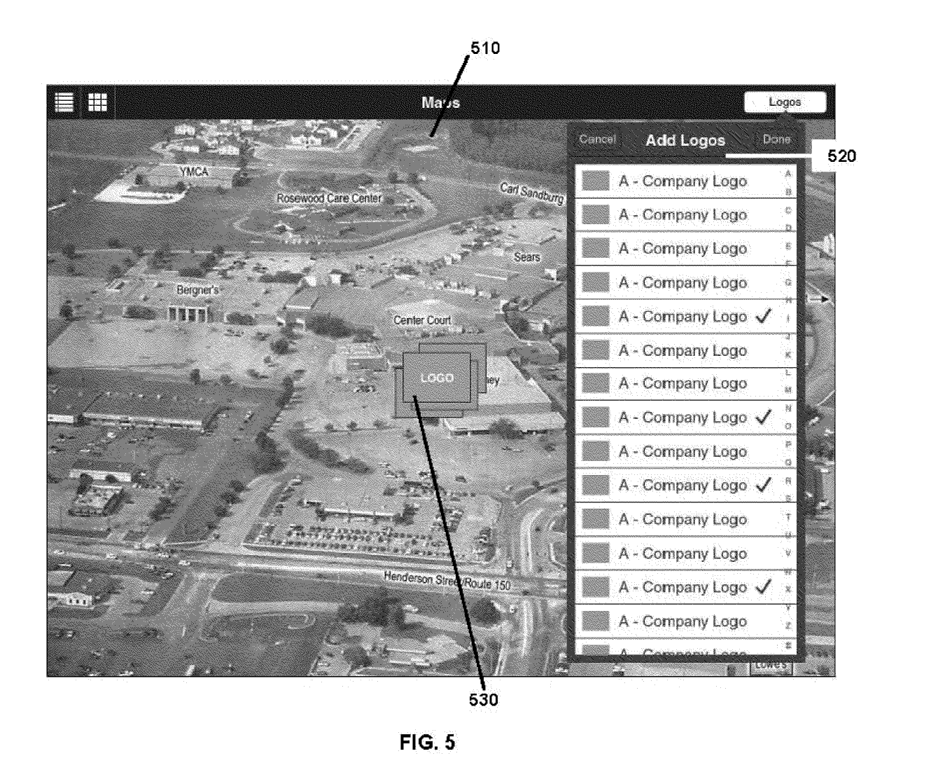

FIG. 5 illustrates an example of a map interface with one or more targeted geospatial location. In one possible embodiment, a user device may show a map 510. The map may show a standard view (e.g., simplified view with streets, outlines of buildings, etc.), a satellite view (e.g., showing actual overhead image or angled image of the location), or a hybrid view. In some instances, the map may show a street view (e.g., shown from the perspective of an individual traversing the route). The map may be displayed to anyone using a real estate investment system (e.g., interacting with a real estate investment management software or application). Optionally, the map interface, or a different map interface, may be shown to an individual creating a tour, or participating in a tour.

In some embodiments, an add logos 520 interface or similar interface may be provided. Additional interfaces may be provided that may enable a licensed real estate professional to define a tour route or points of interest, or for an investor to view or gather more information relating to the tour route or points of interest. In some instances, visual indicators 530 may be provided which may emphasize points of interest. Examples of the points of interest may include stops along a tour, or hot spots providing additional information about the points of interest. The visual indicators may be displayed on the map at a location corresponding to their location in the physical world.

In some instances, a licensed real estate professional may create a tour route by defining one or more points along the tour route. The system may automatically provide the tour route between the points along the tour route. For example, the licensed real estate professional may define a start location, end location, and several stopping points. For example, the licensed real estate professional may enter one or more address, latitude/longitude coordinates, or click on a location on the map to drop a pin defining a stopping point. The licensed real estate professional may specify whether the ordering of the stopping points is fixed or variable. The system may automatically suggest a tour route that goes from the start to the end of the tour route and stops at each of the stopping points (e.g., in the specified order, or in any other order). Alternatively, the licensed real estate professional may designate the tour route. The licensed real estate professional may have a desired path or way of showing off a property and may designate the entirety of the tour route. The licensed real estate professional may draw out the travel route on a map shown on a user interface of the licensed real estate professional device. The licensed real estate professional may draw out the travel route free hand, or may click and drag various routes which may be confined to traversable routes based on the desired mode of transportation (e.g., driving, public transit, biking, walking).

When a user (e.g., investor) is taking the tour and traversing the travel route, the investor may view the travel route and one or more point of interest. The investor's current location relative to the travel route and/or the point of interest may be displayed. For example, the investor's current location may be shown on a map. Additional information relating to the one or more point of interest may be displayed. The additional information may be displayed overlaying the map or in a separate page, screen or interface.

A real estate investment management system may permit user to consider one or more scenarios. Such scenarios may be useful for analyzing different financial conditions pertaining to commercial real estate properties. A scenario tool may be provided.

FIG. 2 shows an example of a scenario tool provided in accordance with an embodiment of the invention. In some embodiments, one or more assumptions 210 relating to real estate investments or other financial investments may be provided. Some examples of assumptions may include, but are not limited to purchase assumptions (e.g., Purchase Cost, Capitalization, Sales assumptions, Income Assumptions, Expense Assumptions, Capital Improvement Assumptions, in place rent roll assumptions, future market lease assumptions for rent roll,). Such assumptions may include financial assumptions pertaining to commercial real estate property.

The assumptions may be stored in memory. Examples of memory storage units may include databases. The assumptions may be stored in one or more memory storage unit, or may be provided distributed memory storage environment, such as a cloud computing infrastructure.

Such assumptions 210 may be provided to a scenario tool 220. The scenario tool may generate one or more outputs based on the assumptions provided. The outputs may be generated based on the assumptions accessible via the memory and with aid of a programmable processor. The outputs may relate to financial information for commercial real estate property. Examples of outputs may include but are not limited to NOI at sale, value at sale, loan balance, debt constant, debt coverage, or net present value. Changing the assumptions may cause corresponding changes in the output. In some scenarios, a scenario tool may consider variations to the assumptions provided and the related outputs. In some instances, side by side comparisons of how the changes the in the assumptions affect the outputs may be provided.

In some embodiments, backflow may be provided form a scenario tool 220 to the assumptions 210. Based on an output of the scenario tool, one or more of the assumptions may be considered and/or modified. Based on modifications to assumptions, the results of the new assumptions may be determined by the scenario tool. Thus, the scenario tool may provide feedback that may affect the assumptions that are used for the various scenarios. The feedback may be manually factored into the new assumptions. For example, a user interface may be configured to receive user input relating to the assumptions. Alternatively, the feedback may be factored into the new assumptions in an automated fashion with aid of a programmable processor.

In some embodiments, multiple users may use a scenario tool. Multiple users may be working collaboratively on a single scenario or multiple scenarios. Each scenario may be used by multiple users working collaboratively on each individual scenario in a linked environment. Thus, users may make adjustments to a financial model without creating multiple scenarios. The users may make the changes to same scenario. The scenarios may be shared scenarios.

If a scenario is accessible by multiple users, changes made by the users may be tracked and visible to all users who have access to the shared scenario. The changes may be represented by an activity alert or notification within a data set in order to understand the adjustments that have been made within the linked financial model scenario. Each tracked change could be represented by a color change, highlighting, an addition or removal of an object, specific wording, or other way to represent a change in a specific data set. The visual display may include information about which user made each change. In some instances, the user's initials, login name, IP address, different colors of highlighting or other visual tools may be used to distinguish which changes were made by which users.

If multiple users are accessing the same scenario at the same time, changes made by one user may be viewable by the other users. These changes may appear in real-time. For instance, if a user is changing a value, the change of the value may appear to other users in real-time. If a user is typing, the other users may optionally view the typing in real-time. As previously described, changes may be visually emphasized. In some instances, if the other users also have access to the scenario but are not viewing the scenario at the moment, when they log into the document, the changes that have been made may be visible, emphasized, or tracked for them. Thus, even if the users are not logged into a document while a change is made by another user, the users may catch up and be brought up to speed. Allowing multiple users to a scenario may create a collaborative working environment where each user may be assured that the user is looking at the most updated data. This may be advantageous over situations where separate scenarios or documents are generated, and users may not know if they are working of the same set of data.

A scenario tool may be used to compare different real estate financial data scenarios. The multiple scenarios may be related to the same property or set of properties. The multiple scenarios may be provided for a portfolio of commercial real estate properties. The portfolio may include a single real estate property or multiple real estate properties.

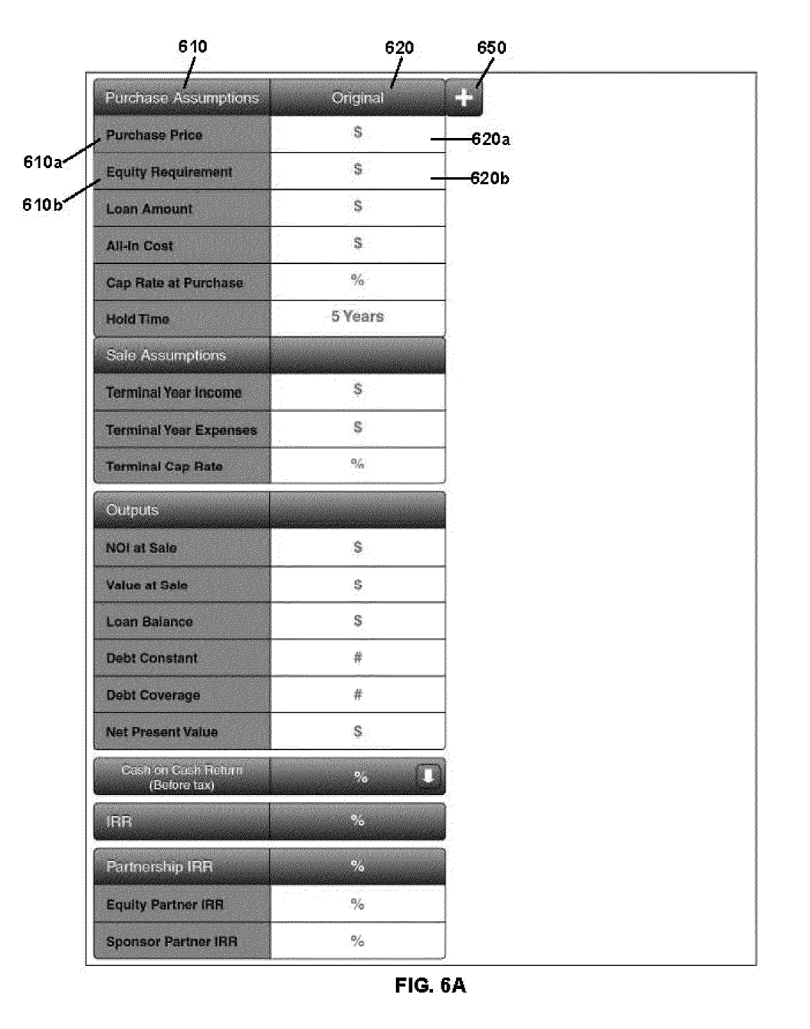

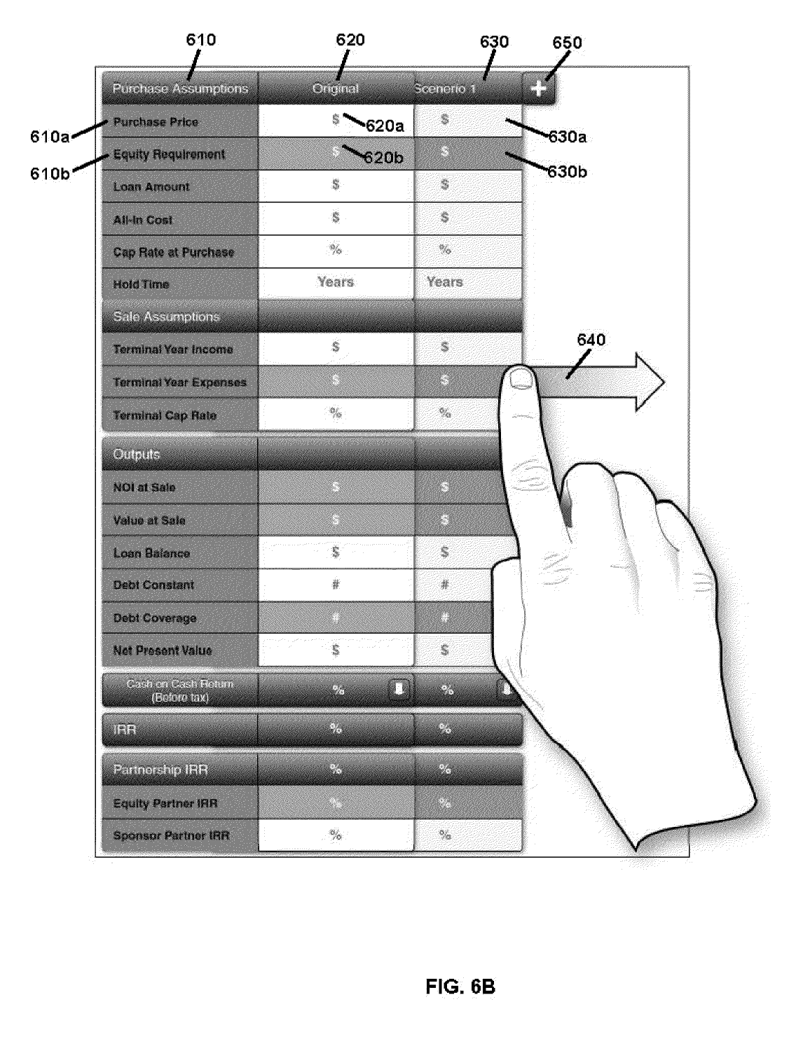

FIG. 6A shows an example of original real estate financial data to be compared using a scenario tool. The original information may include different types or categories of information 610. For example, one or more purchase assumptions, sales assumptions, output, cash on cash return, IRR, or partnership IRR may be displayed. Examples of assumptions may include purchase assumptions (e.g., purchase price 610a, equity requirement 610b, loan amount, all-in cost, cap rate at purchase, hold time) or sales assumptions (terminal year income, terminal year expenses, terminal cap rate). In some instances, one or more outputs may be generated based on assumptions. The outputs may be calculated with aid of one or more programmable processor in accordance with algorithms or rules stored in memory. The assumptions may be entered by a licensed real estate professional or provided based on information from the licensed real estate professional. In other examples, one or more other user (e.g., investor) may provide one or more assumptions. In some instances, the assumptions may be determined on information provided from one or more third party source.

The categories of real estate information 610 may be displayed in a linear fashion. For example, the information may be displayed in a row or column. In some examples, information displayed in a row may be displayed in a horizontal linear fashion while information displayed in a column may be displayed in a vertical linear fashion. The corresponding original values 620 for the various categories of information may also be provided in a linear fashion. For example, the original values may be displayed in a row or column. The original values may be displayed in a linear fashion that is parallel to the categories of real estate information. The original values 620a, 620b corresponding to the categories 610a, 610b may be displayed in a visually mapped manner. For example, the categories and the corresponding original values may be displayed in a linear fashion (e.g., same row, same column). The categories and corresponding original values may be displayed in a linear manner that is perpendicular to the linear display of the categories of real estate information and the original values. For example, if a column is provided for purchase assumptions, and a column is provided for original values of the purchase assumptions, the original purchase assumptions values corresponding to the headings for the purchase assumptions are provided in the same row as the headings for the purchase assumptions.

A scenario adder 650 may be displayed in accordance with some embodiments. Selecting a scenario adder may cause the creation of one or more scenarios which may permit the alteration of one or more assumption.

FIG. 6B shows a user interface through which additional scenarios can be compared to the original real estate financial data. Categories of information 610 may be provided in a linear fashion along with corresponding original values 620 for those categories of information. An additional scenario (‘Scenario 1’) 630 may be added. The new scenario may be added with selection of a scenario adder 650 or via alternative user input, such as a finger swipe 640. For example, the user may tap on a ‘+’ button 650 to create a new scenario. In another example, a user may swipe the user's finger across a touchscreen. In some instances, to add a new scenario, the finger swipe may be in a direction substantially perpendicular to an orientation of the categories of information. For instance, if the categories of information are displayed in a column, the finger swipe may be a substantially horizontal finger swipe. A user can swipe a current presented scenario (e.g. swipe horizontally across the ‘Scenario 1’ column) to provide a new scenario (e.g., provide a new ‘Scenario 2’ column). The user interface may be provided on a touch-sensitive display that may be capable of detecting a swipe. The user may keep swiping to keep adding additional scenarios. A single swipe may result in a creation of a single additional scenario. Two swipes may result in a creation of two additional scenarios.

In some embodiments, columns may be provided for the categories of information 610, original values 620, and one or more scenario 630. The values may be displayed in a side by side manner. For example, for a particular information category 610b, the corresponding original value 620b and the corresponding scenario value 630b may be displayed in the same row or other visually mapped manner.

In some embodiments, a single scenario section (‘Scenario 1’) may be provided. Alternatively, multiple scenario sections (e.g., ‘Scenario 2’, ‘Scenario 3’, etc.) may be provided. In some instances, an unlimited number of scenarios may be added. Alternatively, a limited number of scenarios may be added.

One or more values provided in the various scenarios may be different from one another and/or different from the original values. Providing multiple scenarios may permit a user to vary the assumptions made, and see how the outputs will be affected. Thus, side by side comparison may be provided for how different assumptions affect the outputs. A visually intuitive and comprehensive display is provided for different real estate scenarios.

When a new scenario is added, the default values may be the same as the original values or a previous scenario values. The user may be able to alter the values (e.g., the assumptions) in the new scenario. In some instances, all provided fields may be editable by a user in a scenario. Alternatively, some of the selected fields may be editable by a user in a scenario while some others may not. Optionally, no fields are editable within an original column. In some instances, a new scenario need not have default values and may be blank. The user may enter or alter the various related values or conditions for the scenario.

In some embodiments, a scenario may have one or more input values, and one or more calculated results values. For example, the one or more input values may be assumptions. A user may enter values for the scenarios. Based on the input values, one or more results values may be outputted. The results values may be calculated based on the input values. The calculations may occur with aid of a programmable processor in accordance with one or more algorithm or instructions. In some instances, a user may not edit the results values, and may only edit the input values. Changing an input value may or may not result in a change in the output values. The changes may be reflected in real-time. In some embodiments, some input values may be fixed and/or inalterable. Alternatively, all input values may be changeable.

For example, a list of categories may be presented in a linear fashion. A first scenario may be provided where corresponding original values for the categories may be provided. A second scenario may be added which has corresponding additional values for the categories. Initially, the values in the second scenario may be assigned the same values at the first scenario. A user may alter one of the additional values. Optionally, the user may directly alter one of the input values. The user may or may not be able to directly alter the calculated values. In some instances, the users may only be able to directly alter the input values. Altering the input values may or may not result in an alteration of the calculated values. This may be an indirect alteration of the calculated value. The calculated value may be automatically updated with aid of a processor. In some embodiments, multiple users may be able to access the scenarios simultaneously. Changes made by one of the users may be viewed by the other users. The updates made by one of the users may be seen by the other users in real-time or within a short period of time thereafter (e.g., within an hour, within half an hour, within 10 minutes, within 5 minutes, within 3 minutes, within 1 minute, within 30 seconds, within 15 seconds, within 10 seconds, within 5 seconds, within 3 seconds, within 1 second). Similarly, one of the users may create a new scenario. The new scenario may also be viewed by the other users.

In one illustration, a scenario comparison may be provided on a user interface of a user device. A column of categories of real estate information 610 may be provided. The categories of real estate information may include input categories, such as various purchase assumptions and/or sales assumptions. The categories of real estate information may include results categories, such as outputs. A second column may be provided showing original values 620 corresponding to the categories of real estate information. Original purchase assumptions and/or sales assumptions may be displayed. The related original output values may also be displayed. A first scenario column 630 may be provided. The first scenario column may show values corresponding to the categories of real estate information. For instance, the first scenario purchase assumptions and/or sales assumptions may be displayed. The related first scenario output values may be displayed. The first scenario output values may be calculated based on the first scenario purchase assumptions and/or sales assumptions. The first scenario assumptions may have at least one value that is different from the original assumptions. For example, the purchase price in the first scenario may be different from the original purchase price. In some instances, the first scenario assumptions may have one or more value that is the same as the original assumptions. For instance, the equity requirement, loan amount and all-in cost may be the same in the first scenario, as in the original column. A user may be able to easily view in a side by side manner which assumptions are the same and which are different. A user may also be able to view in a side by side manner how the outputs are different based on different assumptions.

A second scenario, third scenario, and/or any other number of scenarios may be added. The new scenarios may be easily added via selecting a new scenario button, or providing a finger swipe across an existing scenario. For each of the scenarios, one or more assumptions may be varied from the original values or an earlier scenario. Thus, multiple variations of scenarios with different assumptions may be simultaneously viewed. Similarly, the outputs provided in the multiple variations may also be simultaneously viewed. The user interface described may advantageously provide an overview of different scenarios within one simultaneous visual display.

In some embodiments, assumptions that are different from one another may be highlighted. Alternatively, assumptions that are fixed or cannot be altered may be highlighted. One or more visual indicator, such as highlighting may occur for various assumption conditions that may permit a user to view multiple scenarios and see where values have changed or are fixed from scenario to scenario.

In some instances, the output provided from the scenario tool may provide feedback or backflow to the assumptions. A user may alter one or more assumptions may be on outputs provided in the various scenarios. The user may create new scenarios including the one or more alterations to the assumptions. Thus, a feedback process may be provided that may enable users to update their assumptions based on information collected, which may lead to further rounds of different scenarios.

Real estate management systems, such as those described herein may have additional features or user interfaces, such as those described elsewhere herein. Some examples are described below.

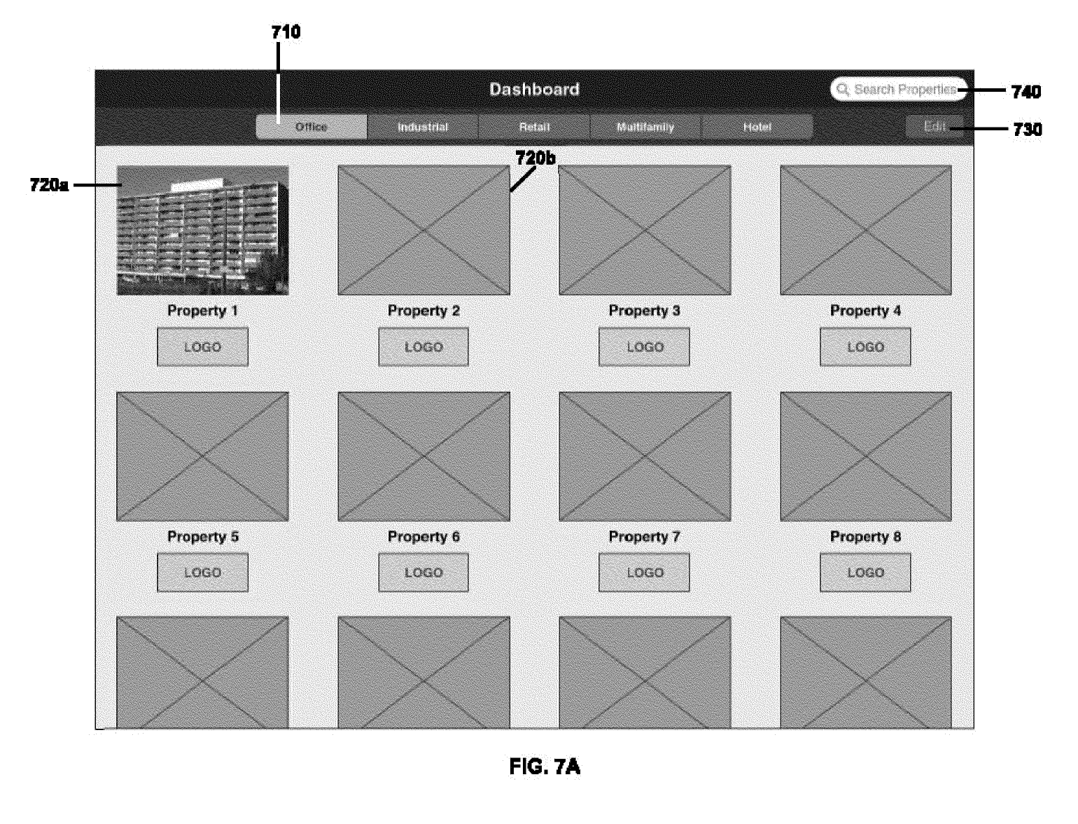

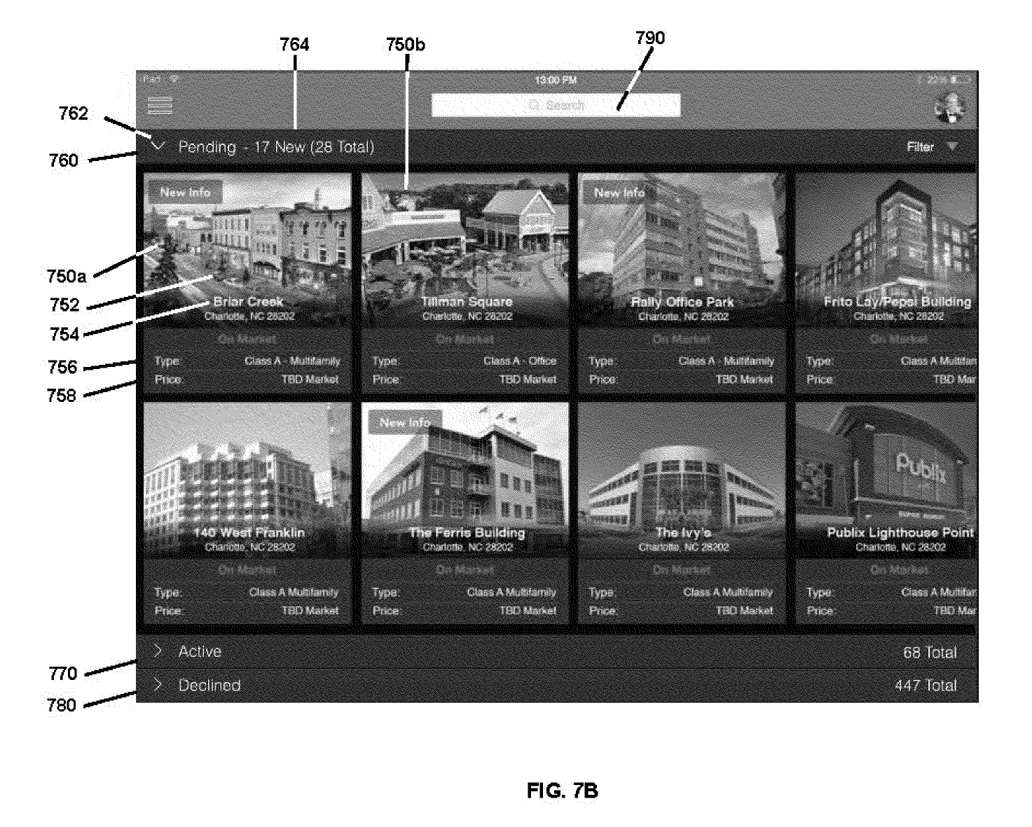

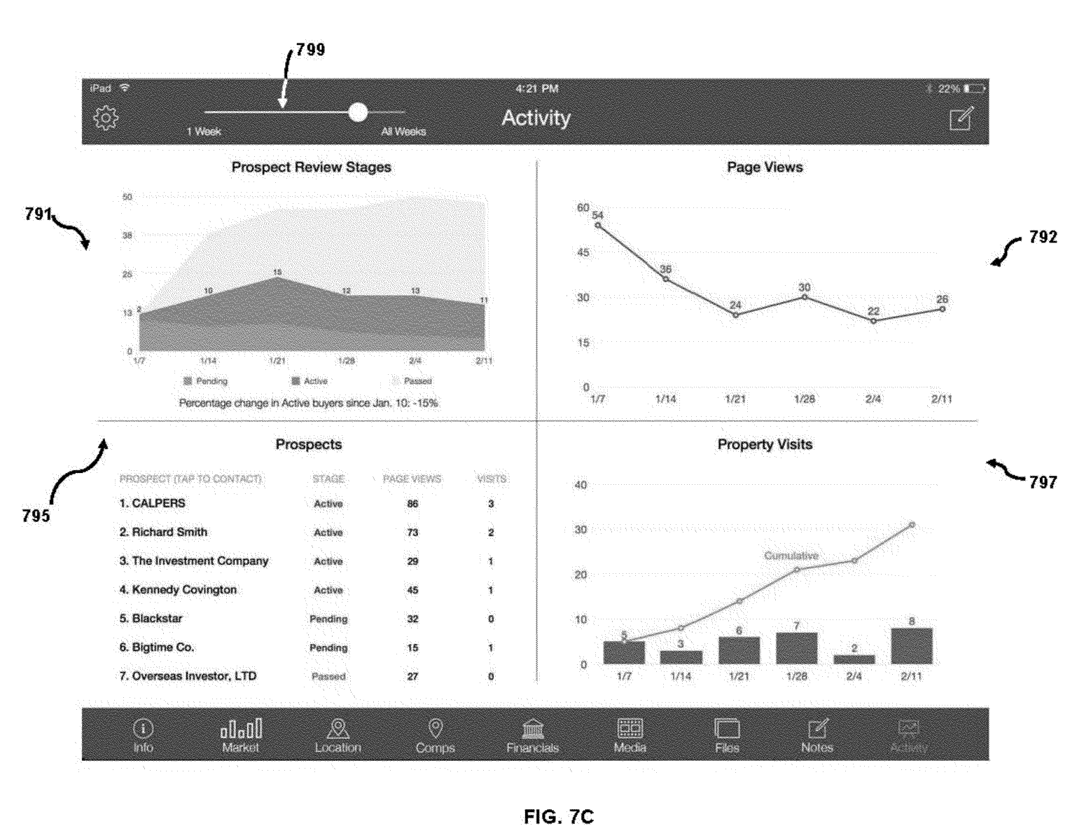

FIG. 7A shows an example of a commercial property dashboard. The commercial property dashboard may permit a user to view and/or organize various properties. For example, the user may be a licensed real estate professional, investor, or any other individual or entity participating in the commercial real estate property investment processor.

The properties may be organized according to one or more categories 710. For example, the properties may be organized as offices, industrial, retail, multi-family, and/or hotels. Any other commercial real estate categories may be provided. The categories may be displayed as a bar, buttons, tabs, or other visual indicator that may enable a user to view properties falling within the selected categories.

The properties 720a, 720b may be displayed in the property categories. For example, office buildings may be displayed under a selection of an ‘Office’ category 710. The properties may be displayed along with an image of the property, a property name, and/or a logo. The properties may be displayed in one or more rows, one or more columns, an array, or any other manner. Selecting a different category (e.g., ‘Industrial’) may cause different properties falling in the different selected category to be displayed. A user may select a specific property to view additional details about the selected property. In some instances, selecting a specific property (e.g., 720a) may lead the user to an offering document for the selected property. In some instances, projects may be provided along with properties. Any description of properties may also apply to projects, which may be displayed along with the properties.

An ‘edit’ feature 730 may be provided. The edit feature may enable a user to edit the one or more categories, or the properties listed according to the categories. Selecting an edit mode may permit a user to reposition the order of the properties and/or reorganize the properties. In some instances a user may add or remove properties.

A search feature 740 may also be provided through which a user may search for a property. The user may search for a property by property name, location, category, logo, owner, price, financials, or any other feature of the property. The search feature may permit a user to search the currently loaded properties within a currently selected filter. The search feature may be provided as a field or any other user interactive interface.

FIG. 7B shows an additional example of a commercial property dashboard. Similarly, to the example provided in FIG. 7A, the commercial property dashboard may permit a user to view and/or organize various properties.

The properties 750a, 750b may be displayed in one or more rows, one or more columns, or an array. The properties may be displayed in any visual manner. The properties may include an image 752 of the property, the address 754 for the property, the type 756 of property, and/or the price 758 for the property. Examples of types of properties may include, but are not limited to, offices, industrial, retail, multi-family, and/or hotels. The properties may be viewed as tiles. The property tiles may be dragged from one location to another.

The properties may be displayed in a manner to be organized by a stage of the property. Examples of property stages may include Pending 760, Active 770, and Declined/Archived 780. Optionally, the number of properties 764 falling into each stage may be displayed. This may include the total number of properties in each stage and/or the number of new properties in each stage. New properties may include properties that entered the stage recently (e.g., within a predetermined window of time, such as 1 hour, 1 day, 3 days, seven days, 14 days, or 1 month). Alternatively, new properties may include properties that are new to the user and have not been previously viewed by the user.

User may navigate between the stages by selecting the stage name or an icon 762 (e.g., chevron, arrow, image, symbol) next to the stage name. Selecting the stage may cause the properties in the selected stage to be displayed. A user may select the stage by using the user's finger on a touchscreen, or a mouse or other interactive device. The display may be collapsible or expandable display. Selecting a stage when it is in its collapsed form may cause the display to expand to show properties in the selected stage. Selecting the stage when it is in its expanded form may cause it to collapse to no longer show the properties. In some instances, a single stage may be selected or ‘expanded’ at a time. Alternatively, multiple stages may be expanded at a time. In some embodiments, the property tiles may be moved from one stage to another. For instance, the properties may be dragged from one stage to another. The property tiles may be moved by touch, hold, or a drag movement.

A search feature 790 may also be provided through which a user may search for a property. The user may search for a property by property name, location, category, logo, owner, price, financials, or any other feature of the property. The search feature may permit a user to search the currently loaded properties within a currently selected filter. The search feature may be provided as a field or any other user interactive interface.

FIG. 7C shows data pertaining to dashboard activity. The activity page may show stages and individuals that have placed a property tile in their dashboard. This may provide actionable insights to a real estate professional on property performance.

For instance, a chart 791 may be displayed, showing prospective review stages. The number of property tiles in each stage over time may be displayed in a graphical manner. The number of page views 793 over time may be displayed. This may include number of page views for a user's dashboard. In some embodiments, data relating to prospects 795 may be displayed. This may include owners or other individuals involved with properties listed on the dashboard. This may include properties in the active stage. The prospects may be ranked according to number of page views, where the prospects with the greatest number of page views are listed at the time. The data may also include a number of property visits 797. This may include number of property visits broken up over time. Similarly, a cumulative number of visits over a period of time may be displayed.

A user may be able to select a time range 799 for the relevant data to be displayed. For instance, the user may select within the past week, month, quarter, year, or all historical data collected. A sliding bar or other visual selector may be provided through which a user may select a timeframe for the data to be displayed. Changing a timeframe may cause the various sections of the data page 791, 793, 795, 797 to be updated.

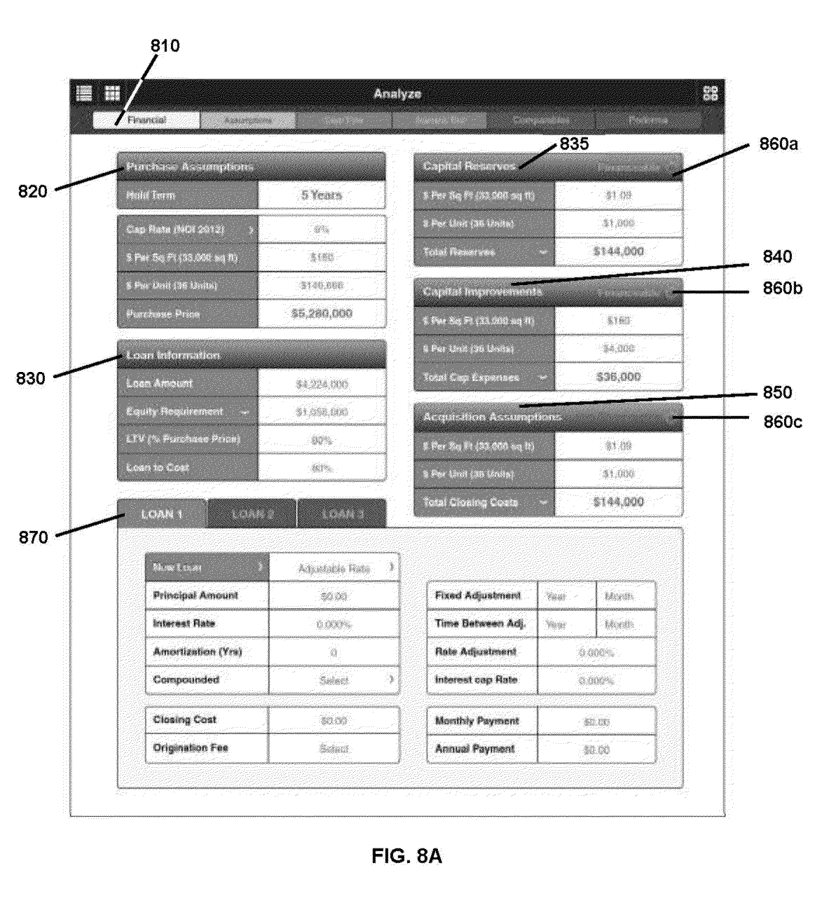

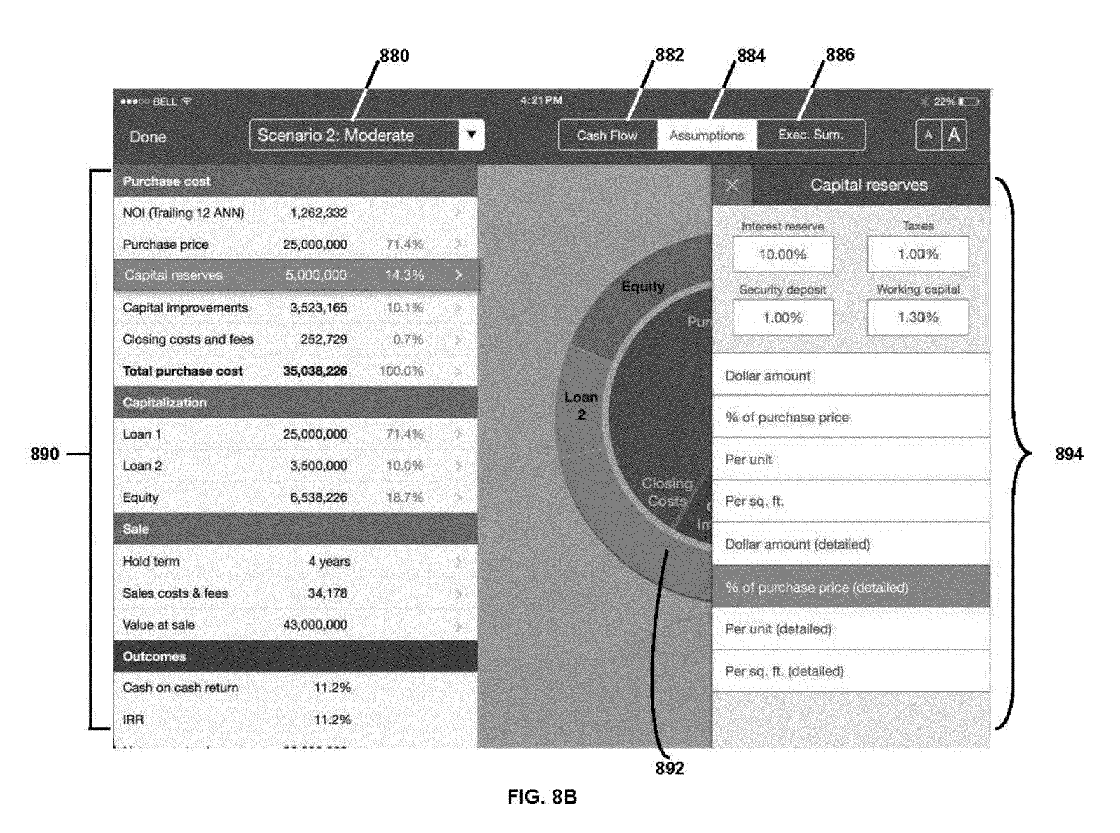

FIG. 8A shows an example of a user interface through which real estate financial data can be analyzed. Various categories of financial information 810 relating to commercial real estate property may be displayed. For example, such categories may include financial, assumptions, cash flow, scenario tool, comparables or proforma. Selecting a category may cause the related information to be displayed. For example, selecting a financial category may cause financial information to be displayed.

The financial information may include one or more sections including purchase assumptions 820 (e.g., hold term, cap rate, $ per square foot, $ per unit, purchase price), loan information 830 (e.g., loan amount, equity requirement, LTV, loan to cost), capital reserves 835 (e.g., $ per sq foot, $ per unit, total reserves), capital improvements 840 (e.g., $ per sq foot, $ per unit, total cap expenses), and/or acquisition assumptions 850 (e.g., $ per sq foot, $ per unit, total closing costs). Such information may be provided in any units. Any reference to dollars may also relate to any other unit of currency (e.g., dollars, euros, pounds, yen, etc.).

An indicator of financeability 860a, 860b, 860c may be provided. In some instances, the financeability indicator may be provided for one or more sections of financial information, such as capital reserves, capital improvements, or acquisition assumptions. In some instances, the financeability indicator may provide a binary output (e.g., ‘Financeable’ or ‘Not Financeable’). In some instances, the financeability for a property may be calculated with aid of a processor in accordance with one or more algorithm. For example, one or more assumptions or loan information may be used to determine whether the project is financeable. Different results may be provided for different second. For example, under capital reserves, the project may be financeable, while under acquisition assumptions the project may not be financeable. In another example, a user may select the financeability indicator. The financeability indicator may enable a user to toggle the financeable status of a current section. Thus, a user may make a determination of whether the section is financeable.

One or more loan sections 870 may be provided. A user may be able to set up multiple loan options for an offering document. Each tab of a loan section may correspond to a different loan option. The various loan options may have one or more different values. The loan options may include information such as, but not limited to, type of loan, type of loan rate, principal amount, interest rate, amortization, compounded, closing cost, origination fee, fixed adjustment, time between adjustments, rate adjustment, interest cap rate, monthly payment and/or annual payment.

In some embodiments, one or more of the top sections may be expanded. In some embodiments, while one or more of the top sections are expanded, the loan sections may be grayed out or in the background. Expanding a top section may provide additional details relating to the top section, or permit a user to enter information or interact in other ways with the top section.

In some embodiments, when a user is working on a loan section, the top sections may be dismissed (e.g., not expanded). The loan view fields may be updated based on a loan type selected by the user. An indicator may be provided of the current selected option. In some portions of the loan section, selecting a field or entry may cause an overlay to be displayed. The overlay may provide one or more options to select for the field or entry.

FIG. 8B shows an additional example of a user interface through which real estate financial data can be analyzed. A user may make a selection of a particular scenario 880. Within the scenario, the user may be able to select viewing cash flow 882, assumptions 884, or executive summary 886. For example, assumptions may be selected.

In some embodiments, financial data 890, such as purchase cost, capital reserves, capitalization, sale, outcome, or other data. The financial data may differ based on the scenario selected. The categories of the financial data may remain the same or may differ based on the scenario selected. The financial data and/or the categories of financial data may remain the same or may differ based on whether the user is viewing cash flow, assumptions, or executive summary. The financial data may be displayed as a panel. The user may be able to alter one or more values in the financial data panel.

In some instances, a graphical representation of the financial data 892 may be displayed. The graphical representation may include a chart, graph, or other type of graphical representation of the financial data.

Additional financial details 894 may be displayed. The additional financial details may be displayed as one or more panels over the graphical representation. The additional financial details may relate to a category in the financial data panel 890. In some instances, a user may view greater detail relating to the selected category in the additional financial details panel. A user may be able to change one or more values.

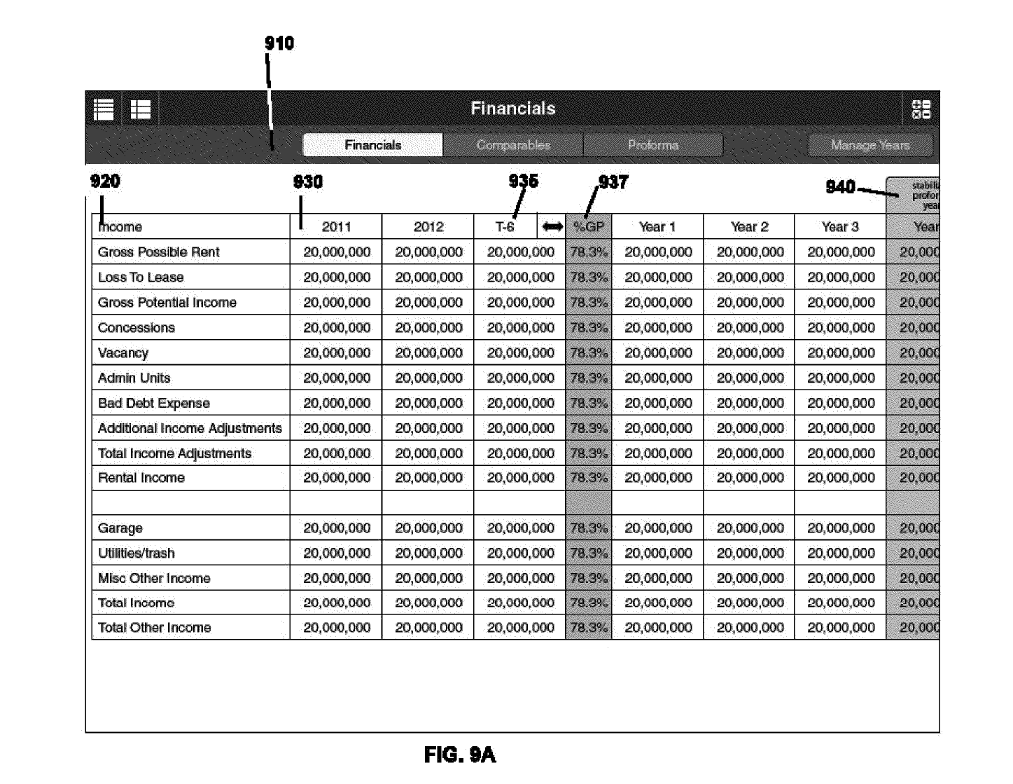

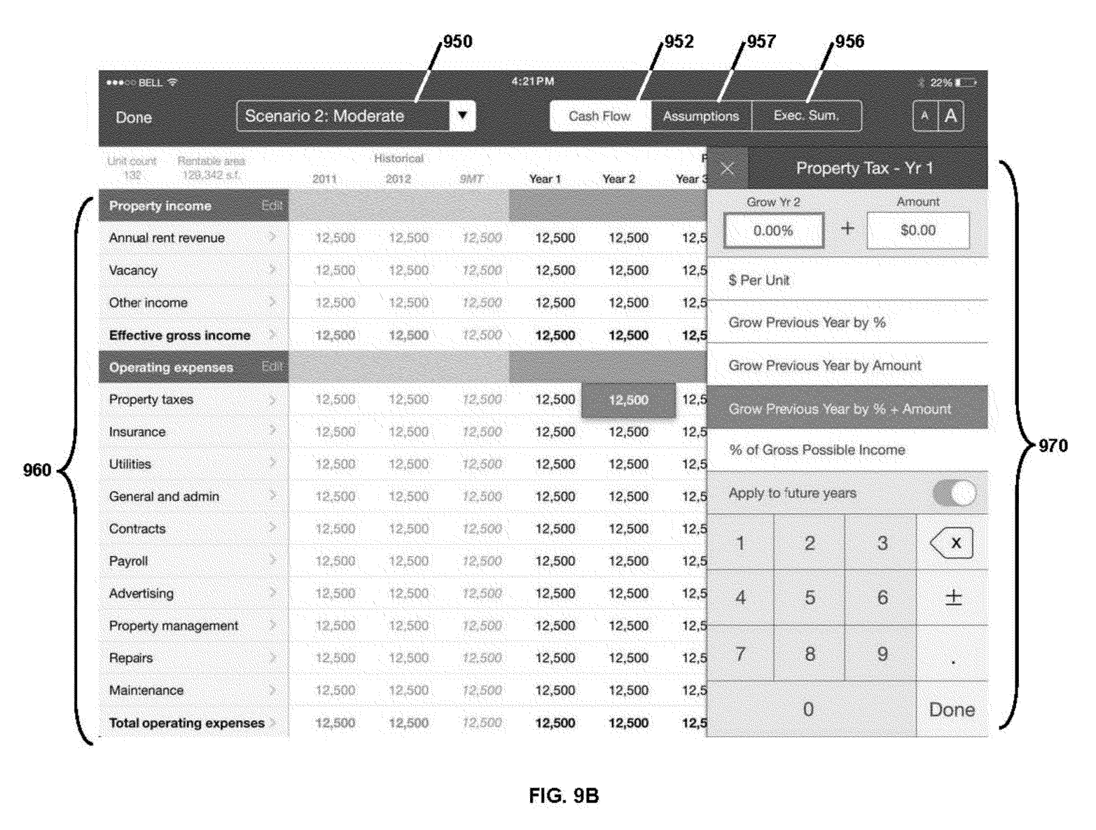

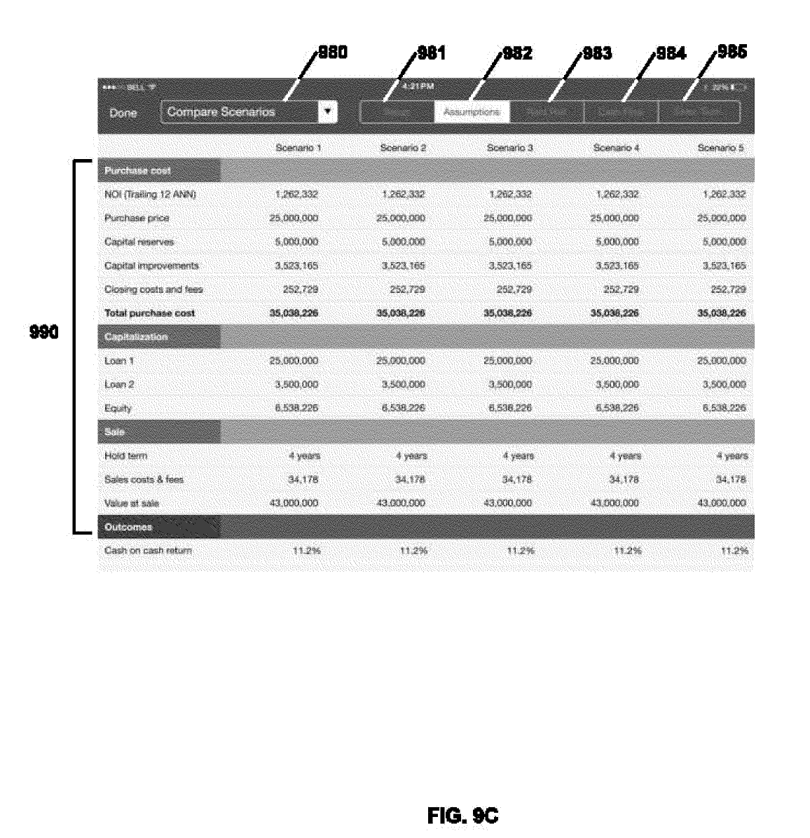

FIG. 9A shows an example of a user interface showing real estate financials in accordance with an embodiment of the invention. Various categories of financial information 910 relating to commercial real estate property may be displayed. For example, such categories may include financial, comparables, or proforma. Selecting a category may cause the related information to be displayed. For example, selecting a financial category may cause financial information to be displayed.

One or more income categories may be displayed 920. For example, income categories may include, but are not limited to, gross possible rent, loss to lease, gross potential income, concessions, vacancy, admin units, bad debt expense, additional income adjustments, total income adjustments, rental income, garage, utilities/trash, misc other income, total income, and/or total other income.

One or more time period 930 may be visually mapped to the income categories. For example, past years or other time periods may be displayed. Projected future time periods may also be displayed. Optionally, the time periods may be displayed as columns.

In some instances, a year to date (YTD) calculation 935 may be performed. A user may be able to select the number of months to use within the year to date calculation. A user may also be able to provide additional calculations next to the YTD calculations. For example, % gross possible income 937 may be displayed, or % total possible income may be displayed. When YTD calculations are adjusted, the remainder of the data may be adjusted accordingly.

The real estate financials chart may also include the calculated stabilized year 940.

A user may be able to add, modify, or remove columns and/or rows. In some embodiments, selecting or tapping on a financial income category may cause the display of an overlay. Options may be provided to modify the name, add a row, delete a row, or show growth %. For example, if a subsection is added, the subsection may be displayed as a new row.

FIG. 9B shows an additional example of a user interface showing real estate financials in accordance with an embodiment of the invention. A user may make a selection of a particular scenario 950. Within the scenario, the user may be able to select viewing cash flow 952, assumptions 954, or executive summary 956. For example, cash flow may be selected.

In some embodiments, financial data 960, such as property income, effective gross income, operating expenses, and/or total operating expenses may be provided. Such categories may be divided into subcategories. For example, property income may include annual rent revenue, vacancy, or other income. Operating expenses may include property taxes, insurance, utilities, general and admin, contracts, payroll, advertising, property management, repairs, and/or maintenance. The financial data may differ based on the scenario selected. The categories of the financial data may remain the same or may differ based on the scenario selected. The financial data and/or the categories of financial data may remain the same or may differ based on whether the user is viewing cash flow, assumptions, or executive summary. The financial data may be displayed as a panel. The user may be able to alter one or more values in the financial data panel.

In some instances, historical details for the financial data may be displayed. For instance, values relating to the past day, week, weeks, month, months, year, or years may be displayed. Similarly, current values or future projections may be displayed. For instance, values relating to the projected year, two years, three years, and so forth may be displayed. The values may be in a manner visually mapped to the categories and/or subcategories of financial data. For example, if the financial data categories and subcategories are displayed as a column, the corresponding values may be displayed in corresponding rows.

Additional financial details 970 may be displayed. The additional financial details may be displayed as one or more panels over the time-based financial values. The additional financial details may relate to a category or subcategory in the financial data panel 960. In some instances, a user may view greater detail relating to the selected category in the additional financial details panel. Optionally, a user may view greater detail relating to a selected value for a selected category in the additional financial details panel. For example, a user may select a value for Property Taxes in Year 2. A user may be able to change one or more values. In some instances, tools may be displayed to aid the user in interacting with the detailed financial data. For example, a number pad or other tools may be provided.

FIG. 9C shows an example of a user interface for finalization after all scenarios have been compared. A user may select an option to compare scenarios 980. The option may be selected from a drop down menu or other interfaces. In some instances, the drop down menu may also present options to the user to view individual scenarios. When a user selects an option to compare scenarios, a user may also be presented with an option to view data pertaining to setup 981, assumptions 982, rent roll 983, cash flow 984, and/or an executive summary 985.

Various categories and/or subcategories 990 of financial data pertaining to properties or a set of properties may be displayed. Examples of categories may include purchase cost, capitalization, sale, and/or outcomes. Subcategories may include NOI, purchase price, capital reserves, capital improvements, closing costs and fees, and total purchase cost under a purchase cost category. They may also include any specific loans and/or equity under a capitalization category. Examples of sale subcategories may include hold term, sales costs and fees, and value at sale. In some embodiments, under an outcomes category, a cash on cash return subcategory may be provided.

One or more scenarios 992a, 992b may be provided. The scenarios may display values relating to each category and/or subcategory. Under a compare scenarios option, multiple scenarios may be displayed simultaneously. A user may be able to view a side by side comparison of various values with the compared scenarios. The values for the comparisons may correspond to the categories and/or subcategories.

The categories/subcategories and values may change depending on whether a user selects an option to view data pertaining to setup 981, assumptions 982, rent roll 983, cash flow 984, and/or an executive summary 985.

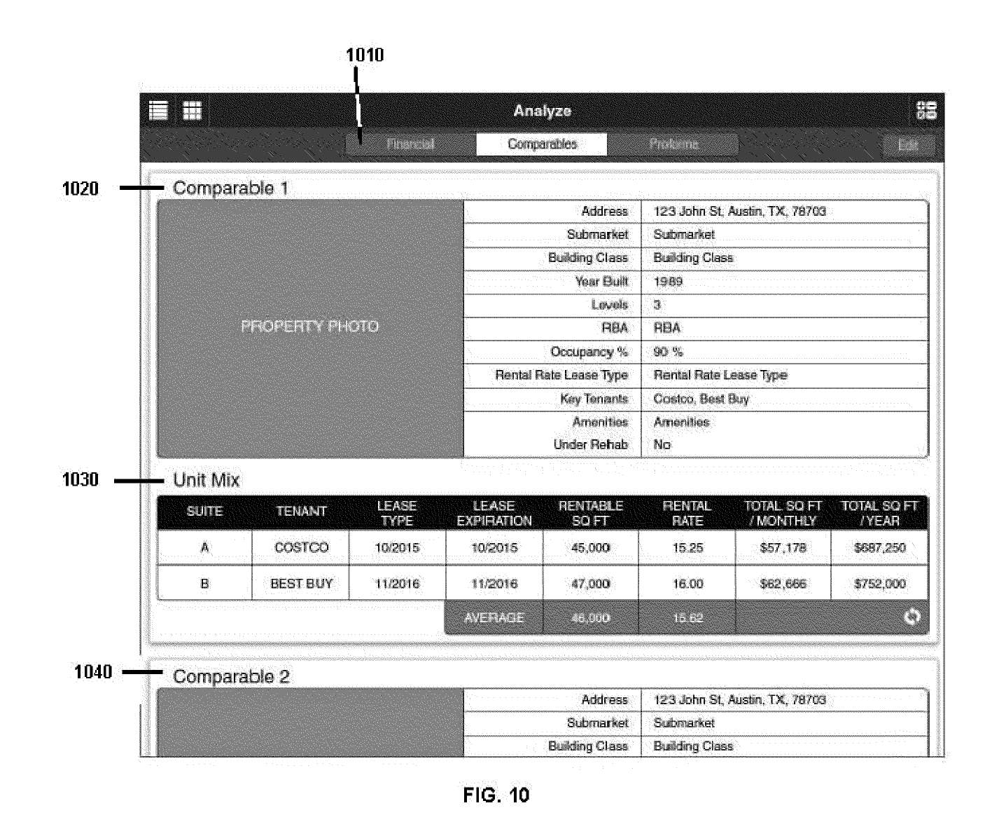

FIG. 10 shows an example of a user interface with real estate comparables. One or more financial analysis categories 1010 for commercial real estate property may be displayed. For example, such categories may include financial, comparables, or proforma. Selecting a category may cause the related information to be displayed. For example, selecting a comparables category may cause comparables information to be displayed.

In some embodiments, a first comparable 1020 may be provided. Optionally, additional comparables 1040 may be provided. A comparable may include information about a property. For example, a property photo, or other image representative of the property may be provided. Additional information relating to the property may include address, submarket, building class, year built, levels, RBA, occupancy %, rental rate lease type, key tenants, amenities, and an indicator whether the property is under rehab.

Details, such as a unit mix 1030 may be provided. The unit mix may include information about one or more suites/rooms/units, tenant, lease type, lease expiration, rentable square feet, rental rate, total square feet/monthly, and total square feet/year. In some instances, averages of one or more of the values may be provided. For example, the average rentable square feet and rental rates for the units provided in the unit mix may be displayed.

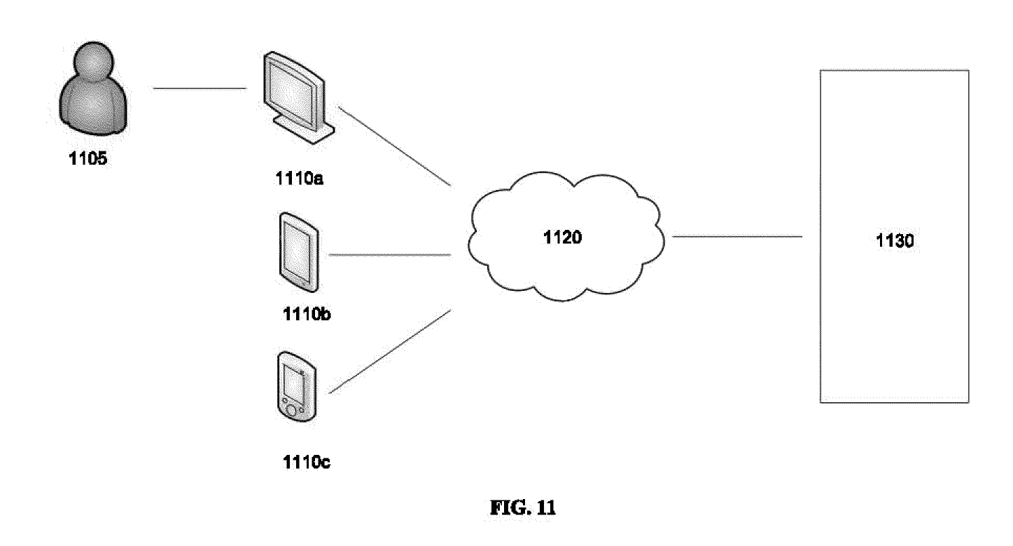

FIG. 11 shows an example of a system for managing real estate investments in accordance with an embodiment of the invention. The system may permit the contribution, organization, and/or display of real estate information, such financial commercial real estate information. In some embodiments, the real estate management system may be implemented as a web-based application, a mobile app, and the like.

The information contribution and delivery system may include a plurality of devices 1110a, 1110b, 1110c. For example a device may be a computer 1110a, tablet 1110b, or smartphone 1110c. In some embodiments, a user 1105 may interact with the real estate management system using one or more such devices. The devices may communicate over a network 1120 with one or more servers 1130. Any depiction of a single server may apply to multiple servers and/or databases. The servers and/or databases may be separate devices or may be integrated into a single device. In some instances a user 1105 of the real estate management system may interact with the system over a network 1120.

In various embodiments, the user 1105 may participate in real estate management. For example, the user may contribute real estate information to the system. For another example, the user may view and/or respond to real estate information provided by the system and/or other users of the system. In some embodiments, the users may include past, present or future licensed real estate professionals, investors, partners, buyers, or sellers of real properties or real estate industry professionals.

One or more devices 1110a, 1110b, 1110c may be used to contribute and/or deliver information to and/or from the system. A device may have a display. The display may permit a visual display of information. The display may include a display of a browser and/or application. An application may be a mobile application. A viewable area of the canvas on the display may be a viewport. The display may be provided on a screen, such as an LCD screen, LED screen, OLED screen, CRT screen, plasma screen, touch screen, e-ink screen or any other type of display device. The devices may also include displays of audio information. The display may show a user interface. A user 1105 of the system may interact with the device through a user interface. A user may interact via a user interactive device which may include but is not limited to a keypad, touch screen, keyboard, mouse, trackball, touchpad, joystick, microphone, camera, motion sensor, IR sensor, heat sensor, electrical sensor, or any other user interactive device.

Examples of devices 1110a, 1110b, 1110c may include but are not limited to a personal computer, server computer, laptop, tablet (e.g. iPad, Surface tablet, Galaxy Tab), satellite phone, smartphone (e.g., iPhone, Android, Blackberry, Palm, Symbian, Windows), cellular phone, personal digital assistant, a wearable device (e.g., iWatch, Google Glass, Oculus Rift), Bluetooth device, pager, land-line phone, or any other network device. In some embodiments, the device may be a mobile device. A mobile device may be easily transportable (e.g., tablet, smartphone). In some instances, the mobile device may be a handheld device. The device may be capable of communicating with a network. In some instances, the device may be capable of communicating with the network wirelessly and/or over a wired connection. The device may be capable of communicating with other devices or networks while the device is in transit. The device may have a programmable processor and/or a memory. The memory may be capable of storing tangible computer readable media which may comprise code, instructions, and/or logics for one or more steps described herein. The programmable processor may be capable of performing one or more steps described herein in accordance with the tangible computer readable media.

Optionally, the device may have a location-sensing component. For example, a GPS tracker may be provided within the device. The device may communicate with a satellite, cell tower, beacon, or other external device to determine the location of the device. Optionally, device may have a clock or other time-keeping component. The clock may be useful for keeping track of timing of one or more events that may occur via the device.

A user may be exposed to content, such as real estate information via a device. The content may be presented to the user in visual, audio, or any other suitable type of format. For example, the content may be visually displayed on a web browser or application on the user's device. In various embodiments, the content may be static or dynamic, passive or interactive. For example, the user may interact with the content via the device. For another example, the user may post or respond to information via the device.

In some embodiments, a plurality of devices may be provided for the system. For example, two or more, 10 or more, 100 or more, 1,000 or more, 10,000 or more, 50,000 or more, 100,000 or more, 500,000 or more, 1,000,000 or more, 5,000,000 or more, 10,000,000 or more, 50,000,000 or more, 100,000,000 or more, or 1,000,000,000 or more devices may be provided. In some embodiments, a pre-selected group of devices may be provided.

In some embodiments, the devices may be configured to access one or more servers 1130. For example, the devices may be configured to communicate with one or more software components or applications running on the one or more servers, for example, to provide and/or retrieve content to and/or from the system. For another example, the devices may be configured to access and/or display content (such as commercial real estate content) hosted by the one or more servers. In an example, the devices may display in a browser content hosted by the server.

In various embodiments, the network 1120 may include the Internet, local area network (LAN), wide area network (WAN), personal area network (PAN), a telecommunications network such as a telephone network, cell phone network, mobile network, a wireless network, or any other type of network. Various technologies and methods may be utilized to communicate with the network 1120. Such technologies and methods may include wireless technology, such as Bluetooth or RTM technology, dial-up wired connection with a modem, a direct link such as TI, ISDN, cable line or the like. In some embodiments, a wireless connection may be provided by one or more wireless networks such as cellular, satellite, or pager networks, GPRS, or a local data transport system such as Ethernet or token ring over a LAN. In some embodiments, the communication technologies may involve wirelessly communication using infrared communication components.

One, two or more servers 1130 may be provided in accordance with an embodiment of the invention. A server may include a memory and/or a processor. The memory may store elements and/or responses to elements. The server may or may not be at a location that is remote to the devices. The server may communicate with the devices over a network such as described above. In some instances, a cloud computing infrastructure may be provided. Any functions described herein may be carried out using a cloud computing infrastructure, such as distributed processing and memory functions. In alternate embodiments, a peer to peer architecture may be utilized by the system.

The server may store data relating to a website or application to be displayed in a browser or app on a user's device. The server may also store data relating to real estate or financial information to be displayed on a user's device. A server may provide content to the devices via the network. In some instances, two-way communication may be provided, where the device may receive a user input and information about the user input may be relayed to the server.

In some embodiments, a server receiving information about a user interaction with a device may or may not be the same as a server providing information to the device. In some instances, one or more third party server, such as a content provider server may provide browser information and/or real estate/financial information to be displayed on a user device. Another set of one or more servers may be configured to receive and/or analyze information from users, or user responses to real estate information. This set of servers may or may not be owned and/or operated by a different entity as the content provider servers.

Real estate information may be displayed on a user interface of a device. Real estate and/or financial information may be contributed by one or more participants in the system. Licensed real estate professionals, investors, partners, sellers, or buyers may provide and/or view information provided in the system. The information may be useful for commercial real estate transactions.

Any descriptions of the user interfaces provided herein may include user interfaces displayed on a device, such as those described herein. The devices may be part of the system.

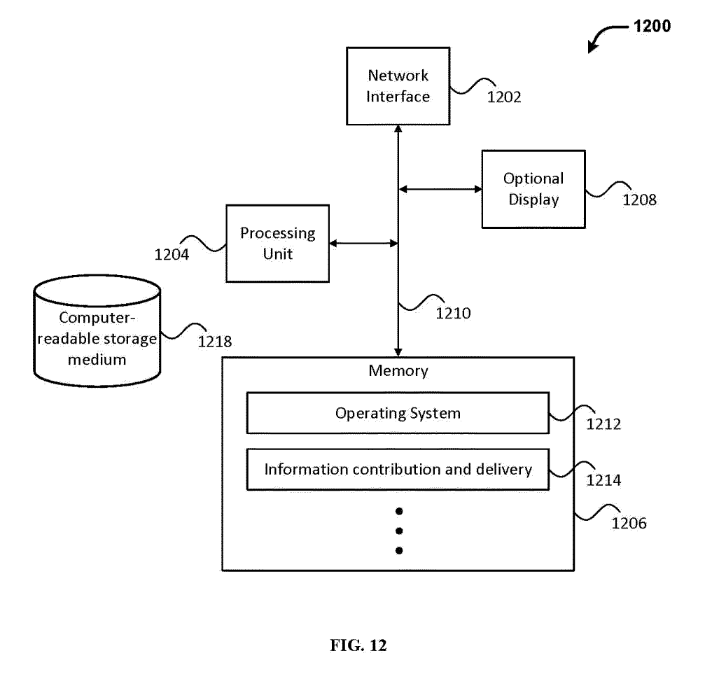

FIG. 12 illustrates example components of a device 1200 for implementing aspects of the present invention, in accordance with at least one embodiment. In some embodiments, the device 1200 may include or may be included in the real estate investment management system discussed in connection with FIG. 11. In some embodiments, computing device 200 may include many more components than those shown in FIG. 12. However, it is not necessary that all of these generally conventional components be shown in order to disclose an illustrative embodiment.

A device 1200 (e.g., computing device) includes a network interface 1202 for connecting to a network such as discussed above. In various embodiments, the computing device 1200 may include one or more network interfaces 1202 for communicating with one or more types of networks such as the Internet, wireless networks, cellular networks, and any other network.

In an embodiment, the device 1200 also includes one or more processing units 1204, a memory 1206, and an optional display 1208, all interconnected along with the network interface 1202 via a bus 1210. The processing unit(s) 1204 may be capable of executing one or more methods or routines stored in the memory 1206. The display 1208 may be configured to provide a graphical user interface to a user operating the device 1200 for receiving user input, displaying output, and/or executing applications. In some cases, such as when the device 1200 is a server, the display 1208 may be optional.

The memory 1206 may generally comprise a random access memory (“RAM”), a read only memory (“ROM”), and/or a permanent mass storage device, such as a disk drive. The memory 1206 may store program code for an operating system 1212, one or more information contribution and delivery routines 1214, and other routines. In various embodiments, the program code may be stored on a computer-readable storage medium, for example, in the form of a computer program comprising a plurality of instructions executable by one or more processors. The computer-readable storage medium may be non-transitory. The one or more information contribution and delivery routines 1214, when executed, may provide various functionalities associated with information contribution and delivery system as described herein.

In some embodiments, the software components discussed above may be loaded into memory 1206 using a drive mechanism associated with a non-transient computer readable storage medium 1218, such as a floppy disc, tape, DVD/CD-ROM drive, memory card, USB flash drive, solid state drive (SSD) or the like. In other embodiments, the software components may alternatively be loaded via the network interface 1202, rather than via a non-transient computer readable storage medium 1218.

In some embodiments, the device 1200 also communicates via bus 1210 with one or more local or remote databases or data stores such as an online data storage system via the bus 1210 or the network interface 1202. The bus 1210 may comprise a storage area network (“SAN”), a high-speed serial bus, and/or via other suitable communication technology. In some embodiments, such databases or data stores may be integrated as part of the device 1200.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A computer implemented method of displaying multiple real estate scenarios, said method comprising:
displaying, on a display of a user device, categories of real estate information to be displayed in a linear fashion;
displaying, on the display of the user device, corresponding original values for the categories of real estate information in a linear fashion that is parallel to the categories of real estate information;
receiving, via a user input interface of the user device, a user input to create an additional scenario;
displaying, on the display of the user device in response to the user input, an additional scenario with corresponding additional values for the categories of real estate information in a linear fashion that is parallel to the categories of real estate information, wherein the corresponding additional values are the same as the corresponding original values; and
receiving, via the user interface of the user device, a user input to alter at least one of the corresponding additional values.

2. The method of claim 1 wherein the user input to create an additional scenario is provided via a fingerswipe on the display of the user device.

3. The method of claim 2 wherein the fingerswipe is in a direction substantially perpendicular to a linear arrangement of the categories of real estate information.

4. The method of claim 1 wherein the categories of real estate information, the corresponding original values, and the corresponding additional values are displayed in columns with each individual category of real estate information, a corresponding original value to the individual category and a corresponding additional value to the individual category in the same row.

5. The method of claim 1 wherein the at least one corresponding additional value that is altered via the user input is a real estate assumption.

6. The method of claim 5 further comprising displaying, on the display of the user device, an updated corresponding additional value that is a calculated results value, based on the altered at least one corresponding additional value.

7. The method of claim 1 further comprising receiving, via user input interfaces of other user devices, user inputs to modify displayed scenarios or to create a further additional scenario.

8. The method of claim 7 further comprising displaying, on the display of the user device, updates to the displayed scenarios in real time in response to the user inputs from the other user devices.

9. A system for displaying a program, said system comprising:
a user input interface configured to receive a user input;
a display screen on a user device comprising a user interface that displays (1) categories of real estate information to be displayed in a linear fashion, (2) corresponding original values for the categories of real estate information in a linear fashion that is parallel to the categories of real estate information, and (3) an additional scenario, in response to a user input to create the additional scenario through the user input interface, with corresponding additional values for the categories of real estate information in a linear fashion that is parallel to the categories of real estate information, wherein the corresponding additional values are the same as the corresponding original values; and
a processor that is programmed to receive a signal from the user input interface indicative of a user input to alter at least one of the corresponding additional values and generate a display signal that causes the display screen to display the altered corresponding additional value.

10. The system of claim 15 wherein the user input interface is a touchscreen and the user input is a fingerswipe.

11. The system of claim 9 wherein the corresponding original values and the corresponding additional values include real estate assumptions and calculated results values, wherein the calculated results values are calculated based on the real estate assumptions.

12. The system of claim 11 wherein the user input can be used to directly alter a real estate assumption and can not be used to directly alter a calculated results value.

13. A computer implemented method for providing a real estate tour comprising:
receiving, and storing in memory, geospatial information for a tour having one or more hot spots;
associating, and storing in the memory, additional information with the one or more hot spots;
receiving, from a user device having geospatial tracking capability, information about the geospatial location of the user; and
displaying, if the user device is within a predetermined distance of an individual hot spot of the one or more hot spots, the additional information associated with the individual hot spot.

14. The method of claim 13 wherein the additional information includes real estate investment links, images, video, audio, or notes.

15. The method of claim 13 wherein the user device is a smartphone or tablet.

16. The method of claim 13 wherein the user device is a wearable device.

17. The method of claim 16 wherein the additional information includes an augmented reality image of an unbuilt property at the hot spot based on the geospatial tracking capability what is displayed to the user through the wearable device.

18. The method of claim 13 wherein the tour occurs on a single property and multiple hot spots on the property.

19. The method of clam 13 further comprising displaying, on the user device, a map of the tour and the location of the user device relative to the tour.

20. The method of claim 13 further comprising providing an alert, on the user device, that a user is near a start of a tour when the user is within a predetermined distance of the start of the tour.
